(19) United States
(12) Patent Application Publication
(10) Pub. No.: US 2018/0160629 A1
(43) Pub. Date: Jun. 14, 2018

(54) ULTRASONIC TREATMENT OF SEEDS

(71) Applicant: Bruce K. REDDING, JR., Broomall, PA (US)

(72) Inventor: Bruce K. REDDING, JR., Broomall, PA (US)

(21) Appl. No.: 15/577,243

(22) PCT Filed: May 26, 2016
(86) PCT No.: PCT/US16/34397

§ 371 Date: Nov. 27, 2017

Related U.S. Application Data
(60) Provisional application No. 62/230,031, filed on May 26, 2015.

(51) Int. Cl. A01G 7/00; A01C 1/00; G10K 15/04

(52) U.S. Cl. CPC A01G 7/00; G10K 15/04; A01C 1/00

(57) ABSTRACT

Seeds are subject to ultrasonic treatment to enhance and reduce the time for the germination process. In particular to this invention, the seeds are treated ultrasonically while the seeds are in a dry state. A dry sonification process for a dry seed and apparatus produces a sonically-treated dry seed having an enhanced germination characteristic and providing an enhanced growth characteristic to a plant resulting therefrom. The sonification process includes subjecting the dry seed to be sonically treated to sound energy at a frequency and energy density and applying for a sufficient time such that the sonically-treated dry seed has an enhanced germination characteristic and a plant resulting from the sonically-treated dry seed has an enhanced growth characteristic. The ultrasonic treatment can include applying the ultrasonic sound energy in different alternating waveforms, or in a batch or continuous process, with continuous flow through a helical flow path.

### CROSS-REFERENCE TO RELATED APPLICATION

This application claims the benefit under 35 U.S.C. § 119(e) of U.S. Provisional Patent Application No. 62/230,031, filed May 26, 2015, the disclosure of which is hereby incorporated herein by reference in its entirety.

### BACKGROUND OF THE INVENTION

### Field of the Invention

The invention relates generally to a sonication and imbibition process for the uptake of water or other substances along with dissolved substances into a seed, more specifically, to a method of treating seeds with sound waves for the purpose of imparting to the seed a memory for enhanced uptake of a substance that enhances a growth characteristic of the seed or resultant plant, or otherwise adds value to the seed during commercial processing. In particular, this invention incorporates the discovery that ultrasonically-treated seeds, once planted in the soil, tend to mature at a faster pace than conventionally planted seeds. Several mechanisms are disclosed, including a laboratory device, a pilot batch processing system and finally a design for a continuous processor which applied ultrasound to seeds traveling the length of the processor, which can be a long sonicated pipe to a helix or spiral system.

### Background of the Prior Art

Seed dormancy is a unique form of developmental arrest utilized by most plants to temporally disperse germination and optimize progeny survival. During seed dormancy, moisture content and respiration rate are dramatically lowered. The initial step to break seed dormancy is the uptake (imbibition) of water necessary for respiration and mobilization of starch reserves required for germination. Imbibition is a biphasic process: I) the physical uptake of water through the seed coat and hydration of the embryo; and II) germination as determined by growth and elongation of the embryonic axis resulting in emergence of the plumule and radicle. The two phases are separated temporally, and seed that have completed phase I is said to be “primed seed,” that is, primed for phase II: germination. Phase I of imbibition is also used in the commercial processing of seed, i.e. wet milling fractionation of corn and the malting process for the fermentation of distilled spirits.

Priming of seed by the enhanced imbibing of water is advantageous to plant vigor, e.g. enhanced emergence, growth and yield characteristics. Seed priming also synchronizes the germination of seed resulting in a uniform field of plants that mature simultaneously for maximal yields at harvest. In addition to water, seed priming provides access to load the seed with nutrients, microorganisms, or pest inhibitors to promote seedling establishment. By adding a molecule to the seed during imbibition phase I, the molecule or organism can be stored in the primed seed and therefore, be present at planting. The “loading of molecules,” sometimes referred to a “loading of macromolecules” is very efficient in the seed when compared to the addition of similar molecules to the entire field. An example is the addition of fertilizer to stimulate root growth and hasten seedling emergence. The loading of the fertilizer into the seed prior to planting is more efficacious to the seedling and cost effective to the farmer. Other beneficial molecules to be loaded into seed are hormones such as the gibberelins/gibberellic acid to promote germination, cytokinins for cell elongation and inhibitors of abscisic acid to promote release from seed dormancy. Seed cultivars could be customized to specific growing regions by the addition of triazoles (plant growth regulators which moderate the effects of drought and high temperatures) or fungicides to inhibit the growth of fungi on seed and seedlings in cool, wet soil or insecticides to combat insects that attack seedlings such as corn rootworm. In addition to macromolecules, beneficial microorganisms such as Azospirillum or Rhizobium can be loaded during seed priming as a crop inoculant.

The commercial fractionation of corn begins with wet milling. Corn is a complex mixture of starch, protein, oil, water, fiber, minerals, vitamins, and pigments. Wet milling is the process of separating the corn components into separate homogenous fractions. In Iowa, approximately 20% of the 1 billion bushels of corn harvested each year is wet milled. The wet milling industry and collateral manufacturing represent a prodigious industrial effort. As the wet milling process is constantly refined by new technologies, novel by-products can be isolated in industrial quantities, e.g. ethanol, corn sweeteners, protein peptides, and vitamins C and E. The initial step in wet-milling, steeping, has not been altered by technological innovation. Steeping involves soaking the clean and dried corn (<16% water content) in warm water until it has swollen to 45% hydration. This process takes from 30-50 hr. at temperatures of 120-130° F. During the steeping process, large quantities of water are moved through massive vats of corn in a countercurrent stream. Also, during this time, beneficial microorganisms such as the lactobacteria and Pseudomonas aeruginosa growing in the steep water aid in the proteolytic cleavage of corn proteins. However, the large volumes of steep water and the time required for hydration limit the effectiveness of the bacterial digestion. The digestion by-products are purified from the steep water primarily by evaporative concentration.

The malting process is the first step in the fermentation of grain to produce alcoholic spirits. The quality of the malt (and the resulting fermentation) is dependent upon the synchronous and efficient germination of the grain. Starches stored in the seed are converted into sugars during early stages of germination. At emergence, germination is halted and converted sugars are used during fermentation for the production of ethanol. Historically, the malting process was a labor-intensive task. The grain was spread onto a “malting floor,” imbibed with water from overhead sprinklers, and turned by hand daily over the course of one to two weeks to release trapped heat and gases. At plumule emergence, the starches have been converted to sugars, the germinated grain is kiln dried and ground to form malt. Microbreweries and distilleries still use variations of this old malting technique to produce high quality malt. Some distilleries induce uniform germination by the addition of gibberellic acid (GA) to produce the highest quality of malt for fermentation such as in single malt scotch distillation. GA is the plant hormone which regulates germination. Malt production of this quality is time consuming and expensive.

### Normal Plant Germination

Water is the key factor that aids the germination of a seed. A seed can be prepared for germination by moistening. Care is to be taken not to over soak the seed fully in water. When water penetrates the seed, the seed bulges as shown in FIG. 1. When the seed coat softens, the seed breaks and the seedling emerges. Seeds usually have some amount of stored food inside. When treated with water, this food is supplied to the seedling, aiding germination. FIG. 2 illustrates the growth of a plant from germination to full development.

You will see a wide variety of trees in your surroundings. Trees play an important role in maintaining the ecosystem and keeping the environment refreshing and pollution-free. Whenever you watch small or big trees, plants or shrubs, you must be curious about their growth and life cycle. The life cycle of any plant is divided in different phases and seed germination is basic stage to start the growth of a plant. You may think that a seed is lifeless, but it is not true. It consists of a plant in a resting, embryonic condition. Whenever it gets favorable environmental conditions, it starts to germinate. This process occurs through different steps in seed germination. Inactive seeds lying in the ground needs warmth, oxygen, and water to develop into plants.

### Seed Structure

The seed coat is the outer covering of a seed, which protects the embryo from any kind of injury, entry of parasites and prevents it from drying. The seed coat may be thick and hard, or thin and soft. Endosperm is a temporary food supply, which is packed around the embryo in the form of cotyledons or seed leaves. Plants are classified as monocots and dicots depending upon number of cotyledons.

### Requirements for Seed Germination

All seeds need adequate quantities of oxygen and water and adequate temperature for germination. Some seeds also need proper light. Some can germinate well in the presence of full light, while others may require darkness to start germination. Water is required for vigorous metabolism. Soil temperature is equally important for appropriate germination. Optimum soil temperature for each seed varies from species to species.

### Factors

There are several factors that can affect the germination process. Over watering can prevent the plant from getting enough oxygen. If the seed is deeply planted in soil, then it can use all the stored energy before reaching the soil surface. Dry conditions can prevent germination, as seed does not get enough moisture. Some seeds have such a hard seed coat that oxygen and water cannot get through it. If soil temperature is extremely low or high, then it can affect or prevent the germination process.

### Steps Involved in Germination:

1. The seed absorbs water and the seed coat bursts. It is the first sign of germination. There is an activation of enzymes, increase in respiration and plant cells get duplicated. A chain of chemical changes starts which leads to development of a plant embryo.
2. Chemical energy stored in the form of starch is converted to sugar, which is used during the germination process. Soon, the embryo gets enlarged and the seed coat bursts open.
3. A growing plant emerges. The tip of a root first emerges and helps to anchor the seed in place. It also allows the embryo to absorb minerals and water from the soil.
4. Some seeds require special treatments of temperature, light or moisture to start germination.
5. Steps in seed germination can be different in dicots and monocots.

### Germination in Dicots

During the germination process of dicots, the primary root emerges through the seed coat when the seed is buried in soil. A hypocotyl emerges from the seed coat through the soil. As it grows up, it takes the shape of a hairpin, known as hypocotyl arch. Epicotyl structures, plumule, are protected by two cotyledons from any kind of mechanical damage. When the hypocotyl arch emerges out from the soil, it becomes straight, which is triggered by light. Cotyledons spread apart exposing the epicotyl, which contains two primary leaves and an apical meristem. In many dicots, cotyledons supply food stores to the developing plant and also turn green to produce more food by the process of photosynthesis.

### Germination in Monocots

During germination of grass seeds such as oats or corn, the primary root emerges from the seed and fruit and grows down. Then, the primary plant's primary leaf grows up. It is protected by a cylindrical, hollow structure known as the coleoptile. Once the seedling grows above the soil surface, growth of the coleoptile is stopped and it is pierced by a primary leaf.

Of course, all of the seeds in the ground are not lucky enough to get a proper environment to germinate. Many seeds tend to get dried and cannot develop into a plant. Some seeds get a sufficient amount of water, oxygen, and warmth, and seed germination starts.

### Climate Change and Reduction of Plant Growth Times

As climate change globally can affect the time available for crop growth, generally making conditions for growth more severe and the growing periods shorter, the need to reduce and enhance seed growth and eventual plant production and harvesting within a shorter time period become apparent.

Thus, a need exists for (1) a method to enhance the ability of seeds to imbibe water and other substances and to (2) reduce the time needed for plant growth.

### SUMMARY OF THE INVENTION

The present invention includes several aspects. Non-limiting aspects are enumerated as follows:

Aspect 1. A dry sonification process for a dry seed producing a sonically-treated dry seed having an enhanced germination characteristic and providing an enhanced growth characteristic to a plant resulting therefrom, the sonification process comprising:
subjecting the dry seed to be sonically treated to sound energy at a frequency and energy density and applying alternating ultrasonic waveforms for a sufficient time such that the sonically-treated dry seed has an enhanced germination characteristic and a plant resulting from the sonically-treated dry seed has an enhanced growth characteristic.

2. The dry sonification process of aspect 1, wherein the sound energy is at a frequency of about 15 kHz to about 175 kHz.

3. The dry sonification process of aspect 1, wherein the sound energy is at a frequency of about 20 kHz to about 100 kHz.

4. The dry sonification process of aspect 1, wherein the sound energy is at a frequency of about 20 kHz to about 30 kHz.

6. The dry sonification process of aspect 1, wherein the sound energy is at an energy density of about 0.125 watt/cm² to about 10 watts/cm².

7. The dry sonification process of aspect 1, wherein the sound energy is at a frequency of about 20 kHz to about 30 kHz and at an energy density of about 0.5 watts/cm².

8. The dry sonification process of aspect 1, wherein the sound energy is applied for about 1 minute or more.

9. The dry sonification process of aspect 1, wherein the sound energy is applied for about 1 minute to about 20 minutes.

10. The dry sonification process of aspect 1, wherein the sound energy is applied for about 5 minutes to about 20 minutes.

11. The dry sonification process of aspect 1, wherein the sound energy does not produce cavitation treatment of the sonically-treated seed.

12. The dry sonification process of aspect 1, wherein the alternating waveforms of the sound energy are applied for alternating periods of about 10 milliseconds to about 90 milliseconds.

13. The dry sonification process of aspect 1, wherein the alternating ultrasonic waveforms of the sound energy are any two or more of a sinusoidal waveform, a sawtooth waveform, a triangular waveform and a square waveform.

14. The dry sonification process of aspect 13, wherein the alternating ultrasonic waveforms of the sound energy are a sawtooth waveform alternating with a square waveform.

15. The dry sonification process of aspect 14, wherein the alternating ultrasonic waveforms of the sound energy are applied for alternating periods of about 20 milliseconds to about 80 milliseconds.

16. The dry sonification process of aspect 14, wherein the alternating ultrasonic waveforms of the sound energy are applied for alternating periods of about 50 milliseconds.

17. The dry sonification process of aspect 1, wherein the sound energy is applied continuously.

18. The dry sonification process of aspect 1, wherein the sound energy is applied in a pulsed manner.

19. The dry sonification process of aspect 1, wherein the sonification process is a batch process or a continuous process.

20. The dry sonification process of aspect 19, wherein the sonification process is a continuous process employing a continuous ultrasonic flow pipe.

21. A dry sonification process for continuously treating dry seeds with ultrasonic transmission, the process comprising:

continuously moving the dry seeds for a length of a flow pipe through a helical path within the flow pipe; and

as the dry seeds flow through the helical path within and for the length of the flow pipe, subjecting the seeds to ultrasonic transmission created by ultrasonic transducers arranged along the length of the flow pipe;

the dry seeds flowing through the helical path slurry being subjected to the ultrasonic transmission having such waveforms and being transmitted in a manner so as not to damage the seeds and to produce ultrasonically-treated seeds that have regulated germination characteristics, such that plants resulting from the ultrasonically-treated seeds when the seeds are planted have affected growth characteristics.

22. The dry sonification process of aspect 21, wherein the regulated germination characteristics are enhanced germination characteristics.

23. The dry sonification process of aspect 21, wherein the sound energy is at a frequency of about 15 kHz to about 175 kHz.

24. The dry sonification process of aspect 21, wherein the sound energy is at a frequency of about 20 kHz to about 100 kHz.

25. The dry sonification process of aspect 21, wherein the sound energy is at a frequency of about 20 kHz to about 30 kHz.

26. The dry sonification process of aspect 21, wherein the sound energy is at an energy density of about 0.125 watt/cm² to about 10 watts/cm².

27. The dry sonification process of 21, wherein the sound energy is at a frequency of about 20 kHz to about 30 kHz and at an energy density of about 0.5 watts/cm².

28. The dry sonification process of aspect 21, wherein the sound energy is applied for about 1 minute or more.

29. The dry sonification process of aspect 21, wherein the sound energy is applied for about 1 minute to about 20 minutes.

30. The dry sonification process of aspect 21, wherein the sound energy is applied for about 5 minutes to about 20 minutes.

31. The dry sonification process of aspect 21, wherein the sound energy does not produce cavitation treatment of the sonically-treated seed.

32. The dry process of aspect 21, wherein the alternating waveforms are applied for alternating periods of about 10 milliseconds to less than 400 milliseconds.

33. The dry sonification process of aspect 21, wherein the alternating waveforms of the sound energy are applied for alternating periods of about 10 milliseconds to about 90 milliseconds.

34. The dry sonification process of aspect 21, wherein the alternating ultrasonic waveforms of the sound energy are any two or more of a sinusoidal waveform, a sawtooth waveform, a triangular waveform and a square waveform.

35. The dry sonification process of aspect 34, wherein the alternating ultrasonic waveforms of the sound energy are a sawtooth waveform alternating with a square waveform.

36. The dry sonification process of aspect 35, wherein the alternating ultrasonic waveforms of the sound energy are applied for alternating periods of about 20 milliseconds to about 80 milliseconds.

37. The dry sonification process of aspect 35, wherein the alternating ultrasonic waveforms of the sound energy are applied for alternating periods of about 50 milliseconds.

38. The dry sonification process of aspect 21, wherein the sound energy is applied continuously.

39. The dry sonification process of aspect 21, wherein the sound energy is applied in a pulsed manner.

40. The dry sonification process of aspect 21, wherein the continuous treatment involves recycling the dry seeds through the flow pipe for processing for such time to produce the ultrasonically-treated seeds that have the regulated germination characteristics, such that plants resulting from the ultrasonically-treated seeds when the seeds are planted have the affected growth characteristics.

41. Apparatus for treating dry seeds continuously with ultrasonic transmission, the dry seeds flowing for a length of a flow pipe through a flow path within the flow pipe, the apparatus comprising:

a flow pipe having a flow path from an inlet to an outlet of the flow pipe; and

a plurality of ultrasonic transducers with a power supply for generating the ultrasonic transmission by the transducers, the transducers arranged along the length of the flow pipe and of sufficient number and placement to provide ultrasonic transmission to the flowable slurry of seeds as they travel through the flow path;

the ultrasonic transmission being applied by the ultrasonic transducers in a manner so as not to damage the seeds and to produce ultrasonically-treated seeds that have regulated germination characteristics, such that plants resulting from the ultrasonically-treated seeds when the seeds are planted have affected growth characteristics.

42. The apparatus of aspect 41, wherein the regulated germination characteristics are enhanced germination characteristics.

43. The apparatus of aspect 41, wherein the flow path is a helical flow path formed by a helical tube spiraling for the length of the flow pipe for the helical flow path from an inlet to an outlet of the flow pipe; and the transducers arranged along the length of the flow pipe and of sufficient number and placement to provide ultrasonic transmission to the flowable slurry of seeds as they travel through the helical flow path.

44. The apparatus of aspect 43, further comprising:

a source of supply to supply the dry seeds to an inlet into the helical tube;

an air mover for moving the dry seeds by positive or negative air pressure on the dry seeds the length of the spiral tube;

a jacket over the helical tube which to contain a liquid surrounding the helical tube;

at least one ultrasonic generator to power the transducers capable of imparting ultrasonic energy though walls of the jacket, through the liquid within the jacket and through walls of the helical tube to sonicating the dry seeds flowing through the helical tube; and

an outflow connection from the helical tube through which the ultrasonically-treated dry seeds will pass out of the helical tube.

45. The apparatus of aspect 44, further comprising at least one conduit communicating from the outflow connection to the inlet to recycle the ultrasonically-treated dry seeds through the apparatus until the dry seeds are ultrasonically treated for a sufficient time that the ultrasonically-treated dry seeds have the regulated germination characteristics, such that plants resulting from the ultrasonically-treated seeds when the seeds are planted have the affected growth characteristics.

46. The apparatus of aspect 44, wherein the liquid within the jacket is selected from water or oil.

47. The apparatus of aspect 46, wherein the oil is silicone oil.

48. The apparatus of aspect 43, wherein the helical tube and the jacket are formed from a material which will allow ultrasonic transmission to pass through the material, and wherein the material is quartz glass, stainless steel or flexible plastic.

49. A dry ultrasonically-treated seed produced by the dry sonification process of aspect 1.

50. A dry ultrasonically-treated seed produced by the dry sonification process of aspect 21.

51. A dry ultrasonically-treated seed produced using the apparatus of aspect 41.

The invention relates to sonication of seeds. In an embodiment, the seed to be treated is placed between two ultrasonic transducers which emanate ultrasonic energies to the seed in a dry state. The seed is exposed to sound energy at frequencies of about 15 kHz to about 30 kHz for periods of about 1 minute to about 20 minutes. The invention is the discovery that both cavitation ultrasound and the use of alternating wave form ultrasound can be employed to treat various seeds to increase the speed of germination of the seed, and therefore reduce the time for plant growth maturity. Several mechanisms are disclosed, including a laboratory device, a design for a continuous processor which applies ultrasound to seeds traveling the length of the processor, which can be a long sonicated pipe to a helix or spiral system.

### Cavitational Ultrasound

Sinusoidal ultrasonic energy generates cavitational forces by the adiabatic collapse of micro bubbles in the liquid medium, particularly those bubbles that collapse at the surface of the seed. The ultrasonic cavitational forces an enhanced stable memory for the seeds to imbibe water and/or other substances beneficial to the seed and/or plant. The ultrasonically treated seed can be dried, stored, and later imbibed with a substance that enhances a growth characteristic of the seed or resultant plant. Upon germination, the plant maintains the enhanced growth characteristics.

### Alternating Ultrasonic Transmission

Alternating the ultrasonic transmission where the first part of the transmission is a sawtooth wave form lasting 50 milliseconds, followed by a square wave form lasting 50 milliseconds in the preferred embodiment, but other variations of the alternating sonic waveform can be employed. The alternating ultrasonic transmission applies the ultrasonic energy and the effect of faster seed germination more effectively than the use of Sinusoidal cavitational ultrasonic energy to generate seed germination.

Reference is made to U.S. patent application Ser. No. 13/986,757, filed Jun. 3, 2013, by the same inventor as the present inventor, Bruce K. Redding, Jr., published Dec. 4, 2014, under Publication No. US 2014/0352210 A1, which describes a means of treating seeds in a liquid medium with ultrasound for the purpose of speeding germination and eventual plant maturity.

Another aspect of the invention is to treat seeds, which are in a dry state and not pre-wetted, with ultrasound for the purposes of enhancing the growth of the seed and the resultant plant.

Another aspect of the present invention incorporates a further discovery that ultrasound can be applied directly to the soil, after the seed has been planted, and that reduced germination times can be achieved by the ultrasonic treatment of the seed in place, after the seed has been planted.

A purpose of the invention is to impart to seeds through sonication to reduce the time needed for germination of the seed, and therefore to speed maturing of the resultant plant.

In particular, an object of this invention is to develop a means for the continuous sonification of seeds, wherein the seeds are in a dry state, to increase the speed of germination and the volume of seeds which can be so treated.

These and other objects of the invention will be made clear to a person of ordinary skill in the art upon a reading and understanding of this specification, the associated drawings, and appending claims.

### BRIEF DESCRIPTION OF THE DRAWINGS

FIG. 1 is a photograph of three germinated seeds.

FIG. 2 is a depiction of the process of seed germination to a developed plant

FIG. 3 is a scanning electron microphotograph of a collection of untreated, or raw, wheat seeds.

FIG. 4 is a scanning electron microphotograph primarily of one of a collection of ultrasonically treated wheat seeds, wherein ordinary sinusoidal ultrasound has been applied to the seeds, and wherein resultant cavitation has partially melted the seeds.

FIG. 5 illustrates the effects of conventional ultrasound in the development of intense heating effects caused by cavitation, which could damage the seed shown in FIG. 4.

FIG. 6 illustrates cavitation which is the development of micro-bubbles which upon collapse generate intense thermal effects.

FIG. 7 illustrates a preferred embodiment of this invention, wherein an alternating waveform of ultrasound, first a sawtooth waveform and then a square waveform, is employed to reduce the time needed for the germination of a seed and speed development of resultant plants or crops.

FIG. 8 is a scanning electron microphotograph primarily of one of a collection of ultrasonically treated wheat seeds, processed according to Experiment 1.

FIG. 9 is an illustration of the laboratory system used for treating a slurry of seeds in liquid with ultrasound.

FIG. 10A is a schematic illustration of an ultrasonic treatment process applied to dry seeds in a container according to an embodiment of the present invention.

FIG. 10B is a photograph (top view) of a laboratory embodiment of an ultrasonic treatment apparatus using an embodiment of the process according to the present invention as applied to dry soybean seeds in a container.

FIG. 10C is a photograph (side view) of the laboratory embodiment of the ultrasonic treatment apparatus of FIG. 10A using an embodiment of the process according to the present invention as applied to dry soybean seeds in a container.

FIG. 11A is a photograph of another embodiment of a laboratory system for treating dry seeds in a poly bag (a “sonic bag”) with ultrasound according to an embodiment of the present invention.

FIG. 11B is a series of photographs series of the use of the sonic bag of FIG. 11A for laboratory experiments conducted according to an embodiment of the present invention.

FIG. 12A is a design of an ultrasonic transducer device capable of generating an alternating ultrasonic waveform transmission.

FIG. 12B is a photograph of a transducer coupler array as shown in FIG. 12A including multiple transducer elements.

FIG. 13 is an illustration of a continuous ultrasonic system for treating seeds with ultrasound, involving a spiral or helix flow pipe design that illustrates the helix flow tubing which rotates seeds as they are traveling through the spiral.

FIG. 14 is an illustration of a jacket which fits over and around the spiral or helix flow pipe design illustrated in FIG. 13.

FIG. 15 is an illustration of the continuous processing system, which includes the jacket of FIG. 14 which fits over and around the spiral or helix flow pipe design of FIG. 13.

FIG. 16 is an illustration of the end caps which fit onto the ends of the spiral tubing device of FIG. 15 for the continuous treatment of seeds ultrasonically.

FIG. 17 is a photograph of the spiral seed treatment system using the device of FIGS. 13-16, and which illustrates the placement of transducers along the spiral seed treatment system.

FIG. 18 is a photograph of the completed and assembled helix tube with its jacket using the components shown in FIGS. 13-16.

FIG. 19A is a photograph of the complete helix assembly and system showing the helix connections to a seed feed tank.

FIG. 19B is a photograph showing details of the complete helix assembly and system with ultrasonic transducers along the length of and on all sides of the helix jacket.

FIG. 20 is a photograph of a germination test rack used in the germination experiments.

### DETAILED DESCRIPTION OF THE INVENTION

### Definitions

As used herein, the singular forms “a”, “an”, and “the” include plural referents, and plural forms include the singular referent unless the context clearly dictates otherwise.

As used herein, the term “about” with respect to any numerical value, means that the numerical value has some reasonable leeway and is not critical to the process or function of any method or the operation of the component being described or the system or subsystem with which the component is used, and will include values within plus or minus 5% of the stated value.

### DESCRIPTION

In general, the invention involves a novel sonication process and apparatus to treat dry seeds with ultrasonic energy. The process imparts an enhanced stable memory for subsequent uptake of a substance into a seed, particularly a substance useful for enhancing a growth characteristic of the seed with that characteristic transferring to an advantage for the resultant plant, and for the uptake of water into seeds for processing purposes. The growth characteristic is enhanced through the use of ultrasound, transmitted either using a sinusoidal ultrasonic transmission or one which employs alternating ultrasonic transmissions which rotate from one ultrasonic waveform to another, the ideal present embodiment being sawtooth to square alternating waveforms.

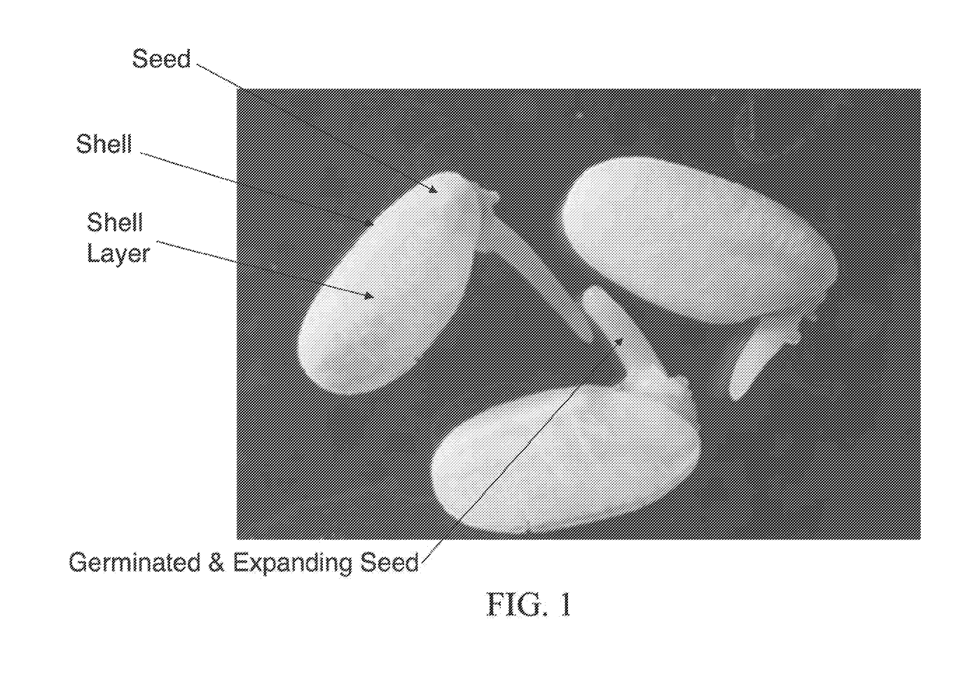

In the way of illustrative examples of applications of the present invention, it is anticipated that the present method is applicable to soften the outer shell layer of a seed shell as seen in FIG. 1, using an ultrasound based treatment system, to better allow the cracking of the seed shell itself, and removing or penetrating the outer shell layer of the seed. This has the effect of speeding the germination of the seed, i.e. the ability of the seed to germinate. As demonstrated herein, the sonication and imbibition process of the present invention would dramatically reduce the time required for steeping by accelerating the uptake of water or other nutrient solution into the seed itself.

The biochemistry of this process begins with the imbibition of water or other nutrients through the seed coat and into the interior of the seed. Using corn seeds as an example: The water reacts with the cell embryo in a manner that releases a chemical known as gibberellic acid (GA), a plant hormone. The GA is transported throughout the seed until it arrives at the aleurone layer that surrounds the endosperm. In the aleurone layer, the GA acts to turn on certain genes in the nuclear cellular DNA. The genes are transcribed resulting in the creation of messenger RNA, which interacts with a ribosome to begin the process of protein synthesis, or translation. The result is the creation of a protein called amylase. The amylase is transported out from the aleurone cells and into the endosperm. The amylase is an enzyme that acts as a catalyst for the hydrolysis of starch into sugar.

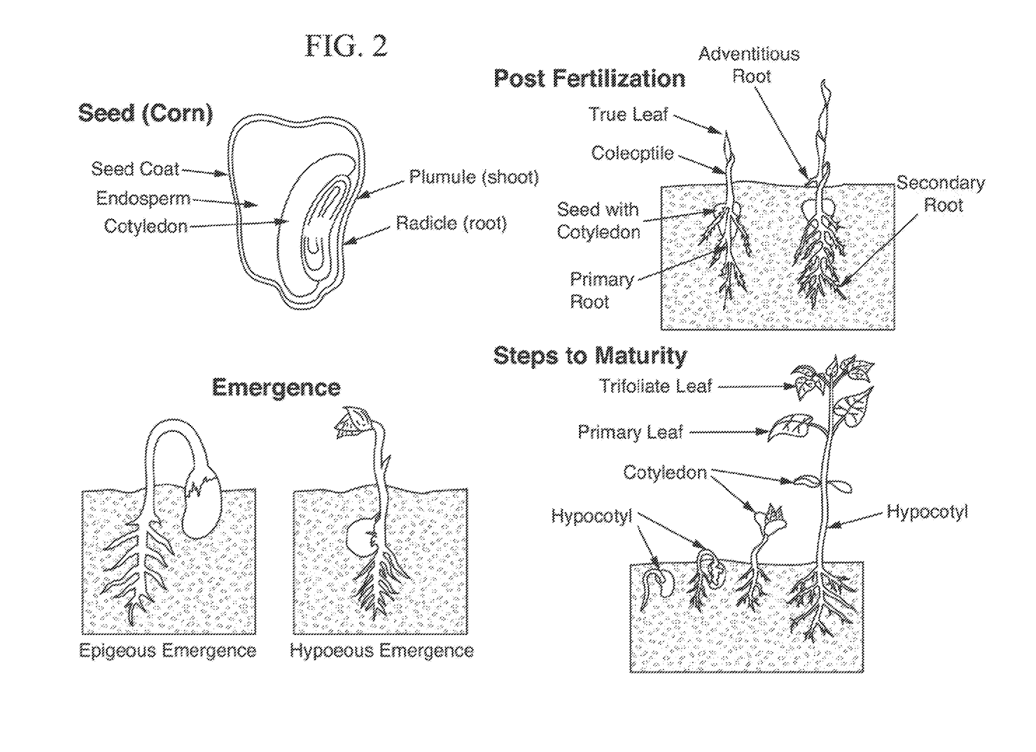

FIG. 2 illustrates the normal growth range from a germinated seed to a mature plant. The goal of this invention is to reduce the time needed to grow a mature plant, and thus reduce the time needed to harvest a particular crop, through the use of ultrasonic transmissions applied to the dry seeds.

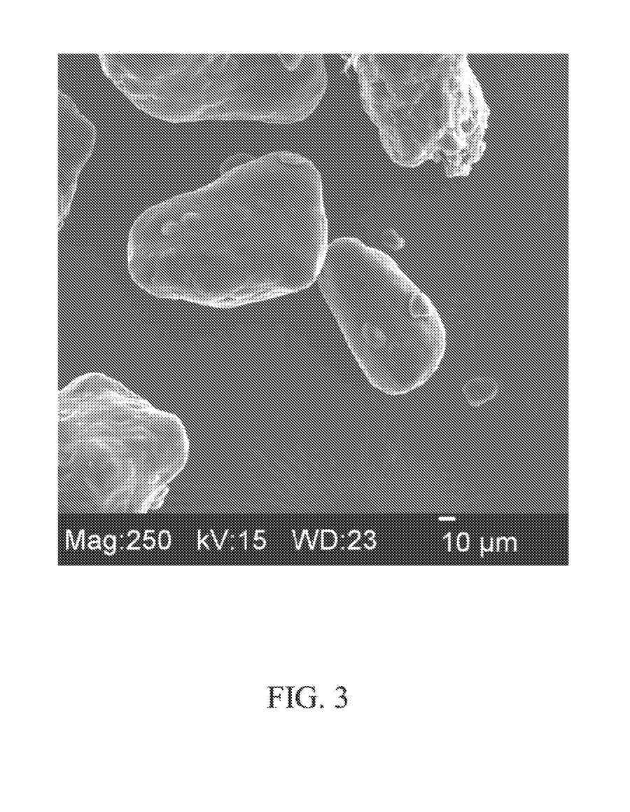

FIG. 3 is a scanning electron microphotograph of a collection of untreated, or raw, wheat seeds having a particle size where 100% of the seeds are less than 60 mesh, that is, pass through a 60 U.S. standard mesh screen having openings of 250 microns.

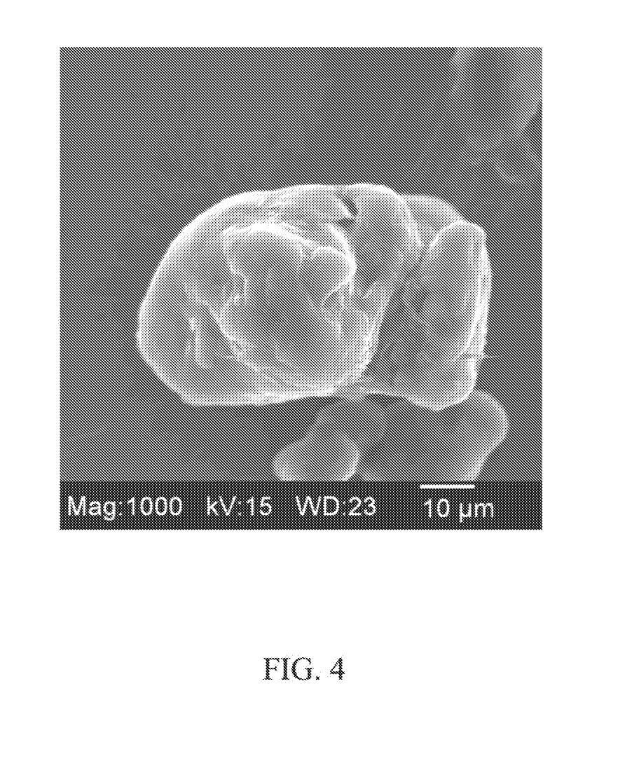

FIG. 4 is a scanning electron microphotograph primarily of one of a collection of ultrasonically treated wheat seeds, wherein sinusoidal ultrasound has been applied to the seeds, and wherein resultant cavitation has partially melted the seeds. In FIG. 4, the wheat seeds were exposed for 5 minutes to sinusoidal waveform ultrasound, a process known to create cavitation energies upon a sonic target, which caused the seed to melt and become inactive.

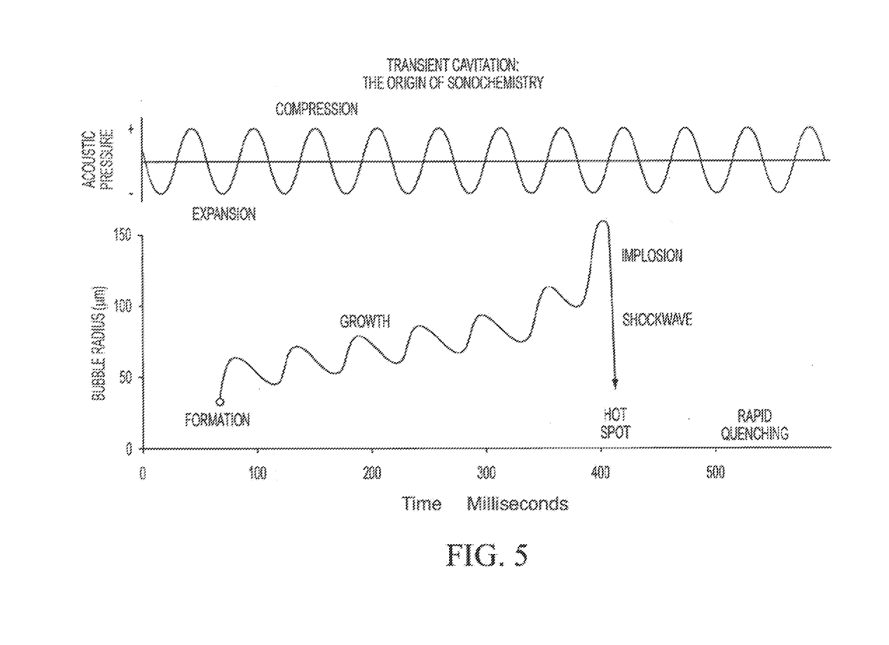

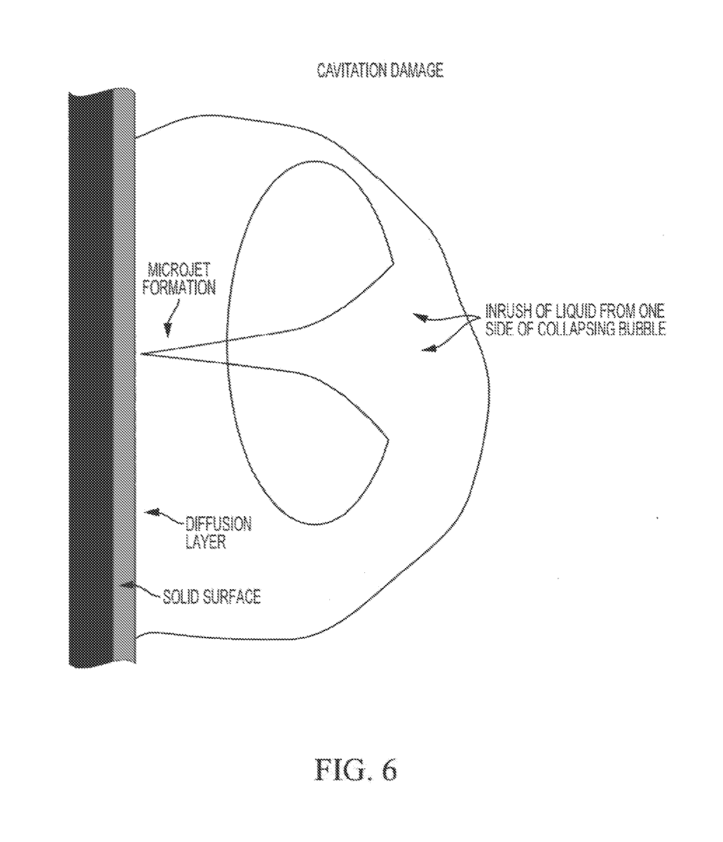

FIGS. 5 and 6 illustrate the process of cavitation. FIG. 5 illustrates the effects of conventional ultrasound, in the development of intense heating effects caused by cavitation almost instantaneously at about 400 milliseconds after application of an ultrasonic sinusoidal waveform with accompanying implosion and creation of a shockwave, which could damage the seed shown in FIG. 4. FIG. 6 illustrates the development of micro-bubbles with cavitation, which upon collapse generate intense thermal effects.

Since cavitation results in mechanical stress, sonication may create or enlarge fissures in the seed coat pericarp similar to scarification, a well-known process by which certain seeds, especially seeds with thick seed coats, are able to germinate. Scarification is believed to accelerate the imbibition of water through the pericarp. Without wishing to be bound by any theory, simple scarification is unlikely to explain the novel effect disclosed herein, since scanning electron micrographs suggest no increase in the number of fissures in treated seed, but do indicate a change in pericarp texture. It has been found that the sonication process accelerates the imbibition of water. Cavitation may also result in physiological or biochemical changes in the seed that prime the germination process, so that upon exposure of the seed to planting conditions, less time is needed for the seed to initiate germination, measured by the time when the radicle pushes through the pericarp. One mechanism proposed for causing physiological or biochemical changes is the production of free radicals by cavitation. Thus, some cavitation may be beneficial, but it is challenging to control and may damage seeds.

FIG. 5 illustrates, however, that ordinary ultrasonic sinusoidal waveform creates cavitation that can be injurious to seeds. In FIG. 4, a wheat seed was exposed for 5 minutes to sinusoidal waveform ultrasound, a process known to create cavitation energies upon a sonic target, which caused the seed to melt and become inactive. In some instances sinusoidal ultrasound may be beneficial in treating particular seeds, but it can also be demonstrated to be harmful in at least some instances of sonic application to seeds, particularly seeds with a relatively thin skin. For example, Rutgers Tomato seeds have a skin thickness of about 0.02515 inch (639 microns), and Georgia Gore wheat has a skin thickness of about 0.1035 inch (2,629 microns). Tomato and wheat seeds are considered to have a relatively thin seed skin, while soybean seeds and corn seeds have relatively thick skin, including a thick husk, estimated to be about 9 times the thickness of the tomato skin thickness for soybeans and about 16 times the thickness of the tomato skin thickness for corn. As a result, the smaller seeds like tomato and wheat are more susceptible to quicker ultrasonic treatment than the larger seeds, like soybeans and corn, which have to be treated longer at the same intensity and frequency. Adjusting the treatment parameters for various types of seeds is within reasonable, rather than undo degrees of experimentation in view of this disclosure.

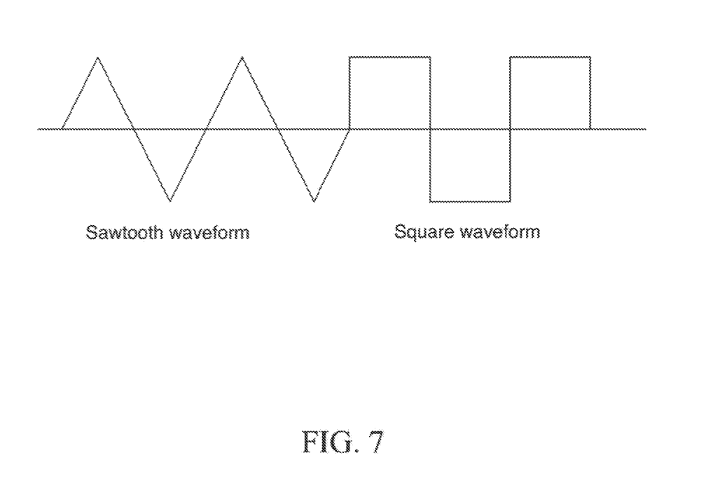

Instead of applying only a sinusoidal waveform of ultrasonic energy, the alternating waveforms of the sound energy are any two or more of a sinusoidal waveform, a sawtooth waveform, a triangular waveform and a square waveform for reducing cavitation, while maintaining the vibratory energy of the ultrasound. Currently, an alternating sawtooth waveform followed by a square waveform depicted in FIG. 7 is preferred.

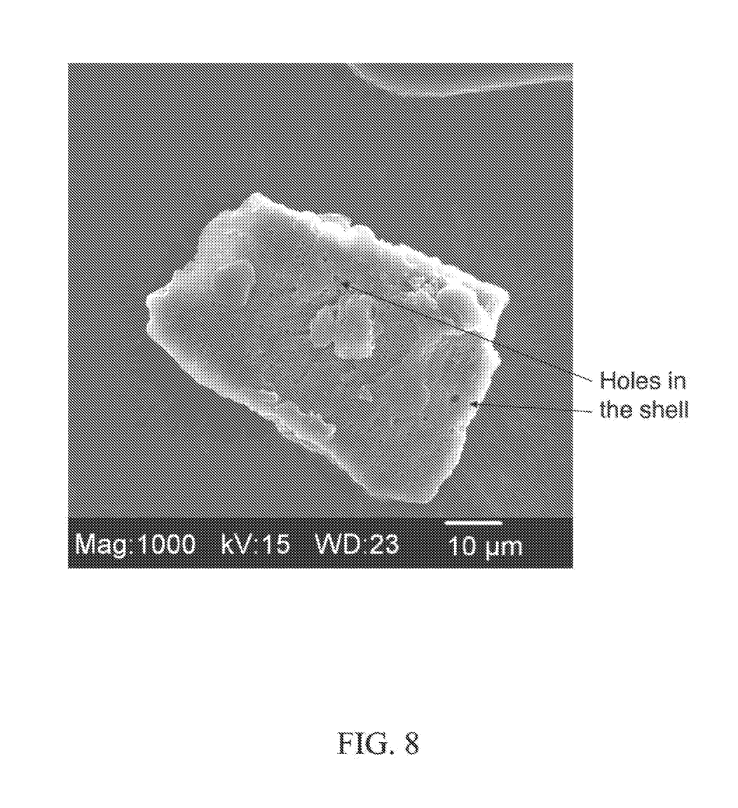

The alternating waveform ultrasound signal is intended to minimize the cavitation effect upon the skin of seeds and avoid damage to the seed shell, but still speed uptake of moisture. One typical result is shown in FIG. 8, where the wheat seed sample was treated with the alternating ultrasound waveforms of FIG. 7, 50 milliseconds using a sawtooth waveform alternating with 50 milliseconds using a square waveform for a period of 20 minutes according to Experiment 1 below. The ultrasound penetrates the seed shell leaving small holes, which can be considered micro-holes or gentle perforations of the wheat seed shell layer. The penetrating ultrasound results in the holes which speed uptake of water and nutrient solutions into the treated seed. Compared to the scanning electron microphotograph of wheat shown in FIG. 4 using a single sinusoidal waveform, the alternating ultrasonic treatment has been found to be less damaging to the shell of the seed.

The sonication is by the application of sound waves at ultrasonic frequencies from about 15 kHz to about 175 kHz, preferably about 20 kHz to about 100 kHz, more preferably about 20 kHz to about 30 kHz. In some tested embodiments, a frequency of about 23 kHz was used. Higher ultrasonic frequencies in the megahertz range are possible but there is a chance of seed damage.

Intensity or power output of the ultrasonic energy can be varied in different seeds for increased speed of germination. In the following experiments an energy density of just 0.5 watt/sq·cm of energy was employed, but ranges could be from about 0.125 mW/sq·cm to as high as about 10 watts/sq·cm.

The sound energy is applied for about 1 minute or more, such as for about 1 minute to about 20 minutes, or for about 5 minutes to about 20 minutes. In some experiments described below, the ultrasonic treatment lasted for various periods, such as about 1 minute, about 5 minutes, about 10 minutes, about 15 minutes and about 20 minutes. Other periods of sound energy application can be applied, not only in relatively easy multiples of each other.

When alternating waveforms are used, as is presently preferred, the alternating waveforms can be applied for alternating periods of about 10 milliseconds to less than about 400 milliseconds. Above about 400 milliseconds, cavitation is more likely as shown in FIG. 5. Preferred timing of alternating waveform application of ultrasound can be for alternating periods of about 10 milliseconds to about 90 milliseconds, for alternating periods of about 20 milliseconds to about 80 milliseconds, and for alternating periods of about 50 milliseconds. Periods of alternating waveforms of sound energy can be for any period within these ranges.

### Apparatus

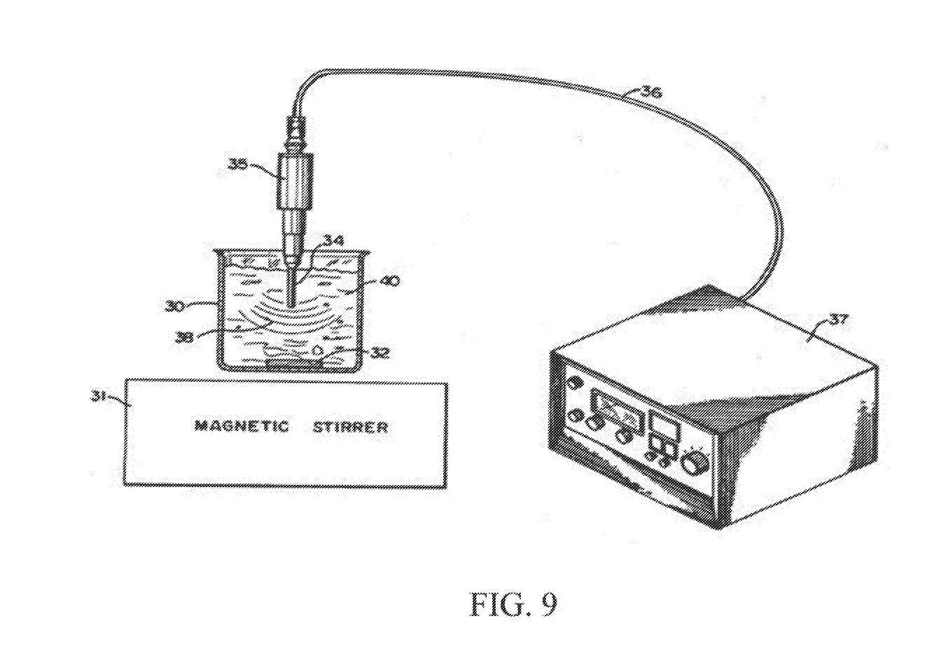

Laboratory apparatus used in the treatment of seeds while the seeds are in a wet state within a liquid slurry, such as water, according to the inventor's previous patent application mentioned above is illustrated diagrammatically in FIG. 9. A quantity of seeds is placed within a beaker or vessel 30, along with water or other liquid to make a liquid slurry of seeds and water or other liquid. A sonic probe 35, powered by an ultrasonic generator 37, is placed within the water or other liquid 40 and is connected to a sonic tip 34 which develops a sonic transmission 38 through the liquid to seeds which are immersed in the liquid, which is water in this exemplary embodiment. A power cable 36 from an ultrasonic generator carries an electronic transmission to the transducer tip 34, which ideally is an ultrasonic transmission of alternating waveforms such as depicted in FIG. 7. Within the vessel is a magnetic stir bar 32 which circulates the seeds within the vessel. A magnetic stirring instrument 31 causes the stir bar to rotate the seeds under the ultrasonic transmission 38.

While the apparatus shown in FIG. 9 was effective in demonstrating the concept of sonically treated seeds and the value of treating seeds in a wet process, it contained two potential limiting factors:
1. The wet treatment process required the seeds to be immediately filtered from the water after ultrasonic treatment, which slowed the process on a commercial scale and made scale-up to a continuous process difficult.
2. The wet treatment process also resulted in damp seeds which needed to be heated to dry the seeds. If not dried properly, the seeds could begin to germinate too soon or could develop mold on their surface and could not be stored long term until sale with the treatment “memory” by which the ultrasonically-treated seeds would effectively germinate faster and result in plants maturing quicker.

Accordingly, a dry treatment process was needed, avoiding the filtration or drying steps associated with the wet treatment process. The present invention satisfies that need.

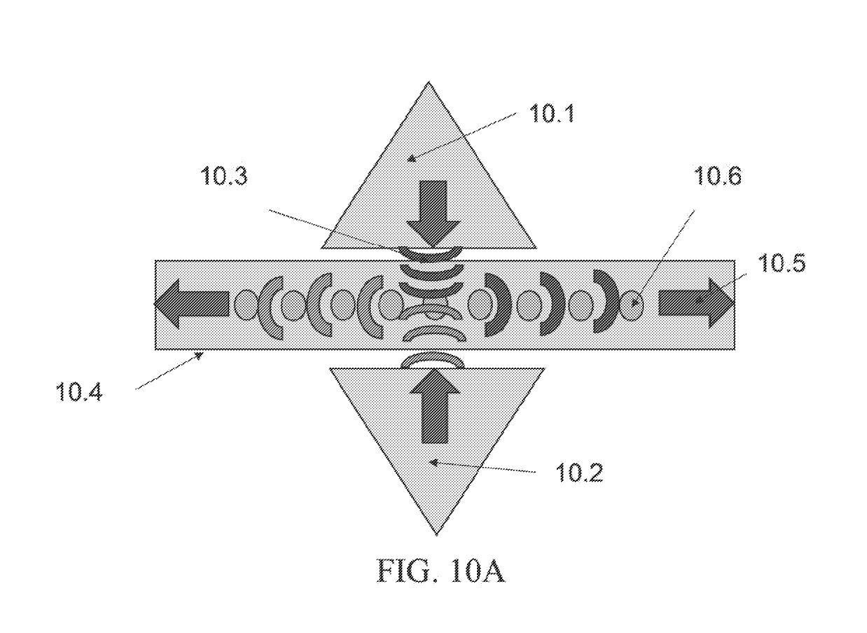

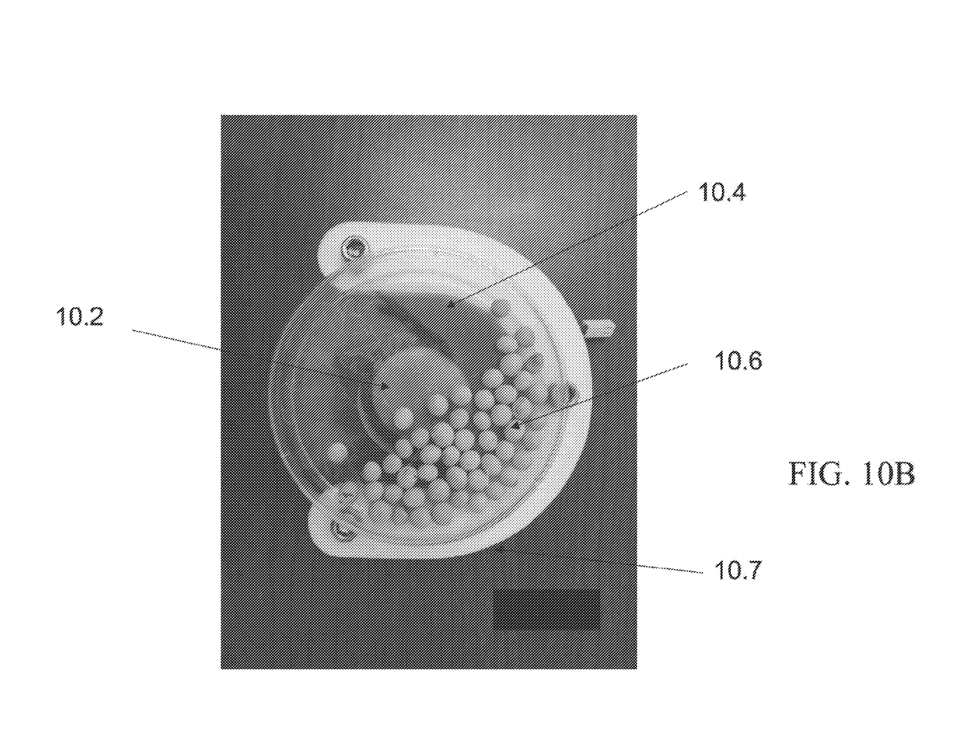

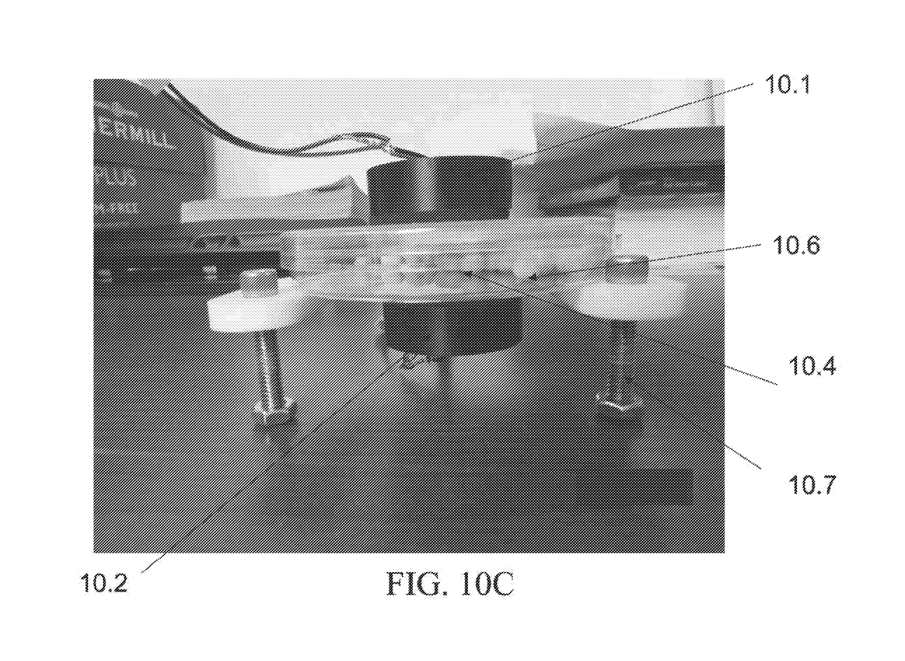

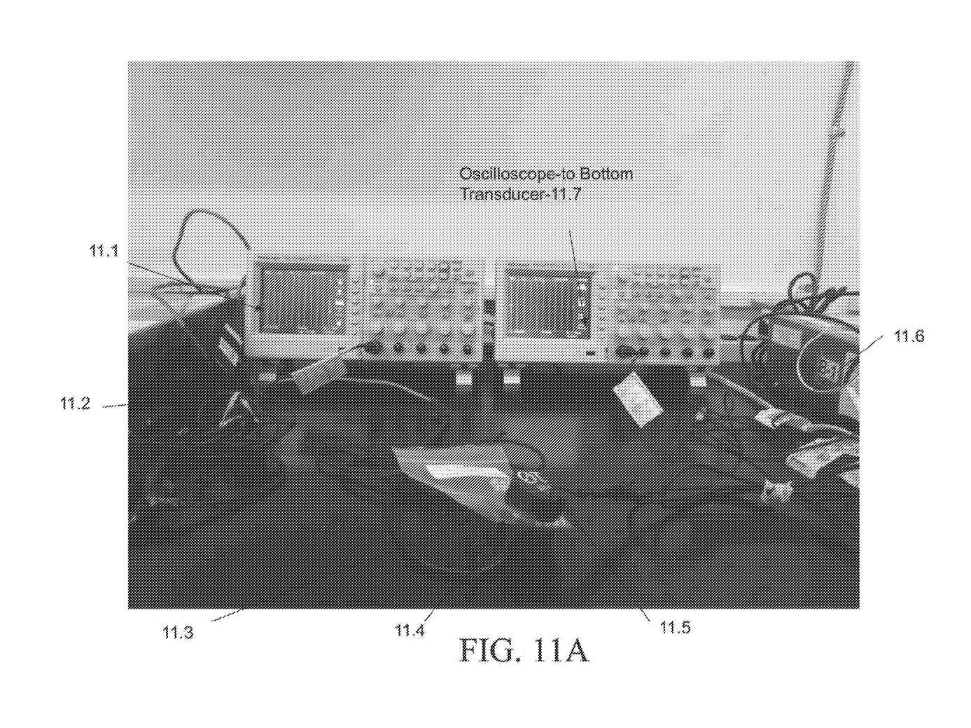

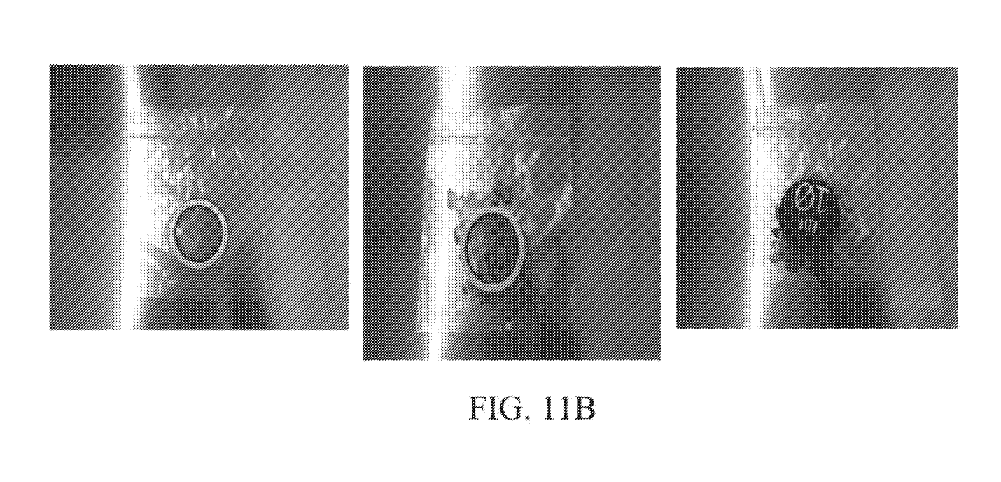

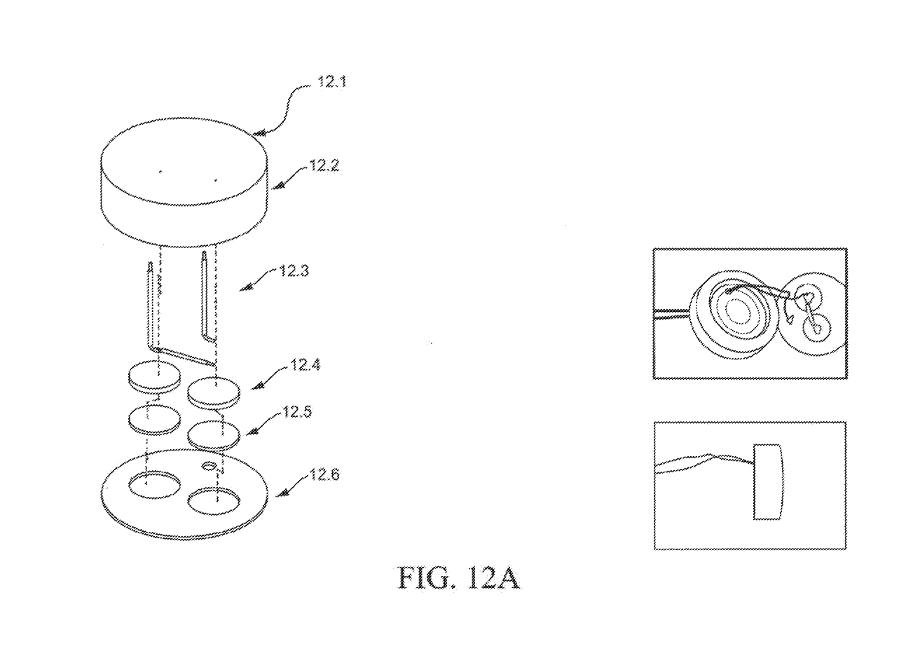

FIG. 10, comprising FIGS. 10A, 10B and 10C, and FIG. 11, comprising FIGS. 11A and 11B, illustrate a simplified version of the ultrasonic treatment for dry seeds, according to one embodiment, typically suitable for batch processing of dry seeds.

FIG. 10A is a schematic illustration of an ultrasonic treatment process applied to dry seeds in a container according to an embodiment of the present invention. Dry target seeds 10.6 are placed inside a container 10.4. The container may be a plastic dish container with a lid (shown in FIGS. 10B and 10C) or a poly bag (shown best in FIGS. 11B and 11C), or any other container which will allow ultrasound to pass through the container. Bags made of a combination of Saran® (polyvinylidene chloride) and polyethylene are ideal for this purpose. The plastic dish must be chosen to allow ultrasound to penetrate and not be reduced in its intensity. Bags or other containers made of materials that can transmit the ultrasound without significantly adversely affecting the ultrasound transmission through the walls of the container are also suitable. Non-limiting examples include quartz glass and stainless steel.

As diagrammatically shown in FIG. 10A, a top transducer 10.1 is placed atop the container 10.4, while another, the bottom transducer 10.2, is placed on the bottom of the container. Ultrasonic transmissions schematically represented as up and down sonic transmissions 10.3 are transmitted through the container by both transducers 10.1 and 10.2. Within the container, the ultrasonic transmissions, schematically shown as lateral sonic transmission through the length or area or volume 10.5 travel throughout the container sonicating dry target seeds 10.6 within the container.

FIG. 10B is a photograph showing a top view of the test assembly used in an experiment conducted for the dry sonification process for the treatment of dry seeds. A petri dish was used as the container 10.4 and was held in place by a holder rack 10.7. In this experiment, dry soy seeds 10.6 were the target seeds in the petri dish. The bottom transducer 10.2 is visible in this top view with the top transducer removed for illustration.

FIG. 10C is a side view of the test assembly used in the experimental design shown in FIG. 10B, with the top transducer 10.1 placed over the container 10.4, held on a container rack 10.7, and with the bottom transducer 10.2 below the container. The target seeds in this experiment were soy seeds 10.6, in a dry state, shown in the petri dish container.

FIG. 11A is a photograph of a laboratory test configuration used in an experiment wherein dry seeds are ultrasonically treated in a poly bag. Oscilloscopes are provided to view the ultrasonic transmission. An oscilloscope 11.1 is connected to the ultrasonic generator 11.2 and feeds the bottom transducer 11.3, attached to the bottom of a sonic test bag 11.4 containing the target seeds in a dry state, here dry soy seeds. An oscilloscope 11.7 is connected to the ultrasonic generator 11.6 and feeds the top transducer 11.5, attached to the top of the sonic test bag 11.4 containing the dry seeds.

FIG. 11B is a series of photographs showing how to the sonic bag was used in the experiments. The left photograph shows a poly bag with an adhesive foam ring placed in the center on both sides of the bag. The center photograph shows the poly bag filled with dry targeted seeds, in this experiment, dry corn seeds. Air is in the bag and the depth of open space in the bag is restricted to 1.5 inches (3.8 cm). The right photograph shows ultrasonic transducers connected to both sides of the poly bag by sticking the transducers to the adhesive foam rings.

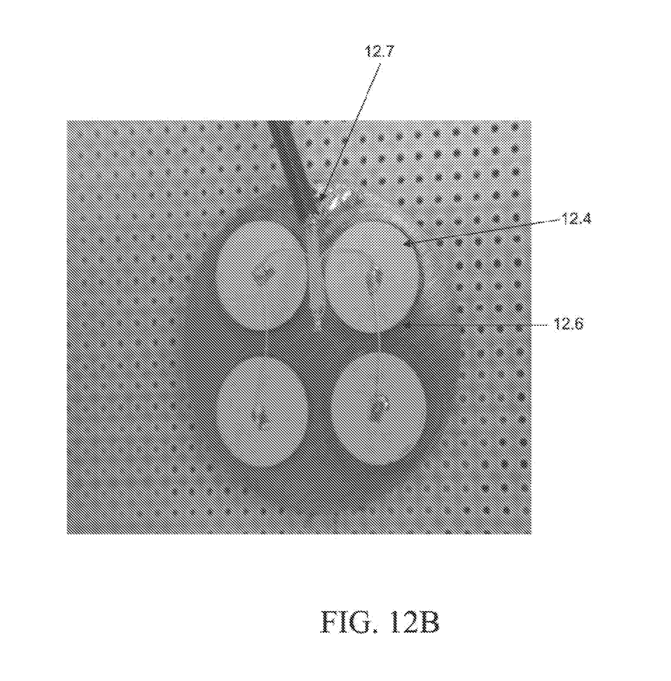

FIG. 12A is a design of ultrasonic transducer system capable of generating an alternating ultrasonic waveform transmission, according to this embodiment of the invention. A single transducer disc, or preferably as shown, multiple transducer discs 12.4 are affixed via a conductive epoxy 12.5 onto a stainless steel face plate 12.6, having an exemplary diameter of 42 mm. A wire connection 12.3 connects the transducers through a reflective cover 12.1 and a backing block of plastic, such as nylon, both also having exemplary diameters of 42 mm, to the ultrasonic driver system. The reflective cover 12.1 is sealed onto the face plate 12.6 by use of a foam rubber ring (not shown). Once sealed, the transducer assembly emanates ultrasound, preferably with alternating waveforms, in one direction. The transducer disc(s) 12.4 may be piezoelectric or magneto restrictive crystals that will generate a mechanical ultrasonic signal in the frequency and mechanical waveform delivered to it electronically by the ultrasonic generator. This exemplary transducer assembly produced an alternating ultrasonic signal of 50 milliseconds sawtooth waveform followed by 50 milliseconds square waveform, with little or no cavitation or intense thermal effects.

A wired transducer assembly is shown in the upper right drawing of FIG. 12A. As shown, one of the wires 12.3 passes through the reflective cover 12.1 and block 12.2 to a ground on the metal face plate 12.6, which is generally a stainless steel disc, and the other wire 12.3 passes through the reflective cover 12.1 and block 12.2 to the top of one or more piezoelectric or magneto restrictive transducer discs 12.4, which are arranged in an array of 1 to 4 discs. In the illustration, two such discs are shown, adhered through the use of conductive epoxy 12.5 to the face plate 12.6. A thin piece of foam rubber or a gasket is placed on the interior rim of the block 12.2 or the reflective cover 12.1. The entire wire assembly is sealed using an epoxy adhesive to form a final completed assembly shown in the lower right drawing of FIG. 12A.

FIG. 12B is a photograph of the transducer coupler array 12.7 with multiple transducer discs or elements 12.4, which is the preferred embodiment of the transducer assembly. The reflective cover 12.1 or block 12.2 reflects sound travelling upwards out of the transducer block, back downward toward the face plate 12.6, improving overall efficiency of the transducer.

The transducer array shown in FIGS. 12A and 12B will develop an alternating ultrasonic transmission as shown in FIG. 7. The preferred combination of waveforms is a sawtooth waveform followed by a square waveform ultrasonic transmission. The time on any particular waveform can be varied to create either or any waveform effect. Exemplary periods of alternating waveforms are discussed above. Alternating waveform ultrasound signals are intended to minimize a cavitation effect upon the skin of the seed and avoid damage to seed shell, but still speed uptake of moisture into the seed.

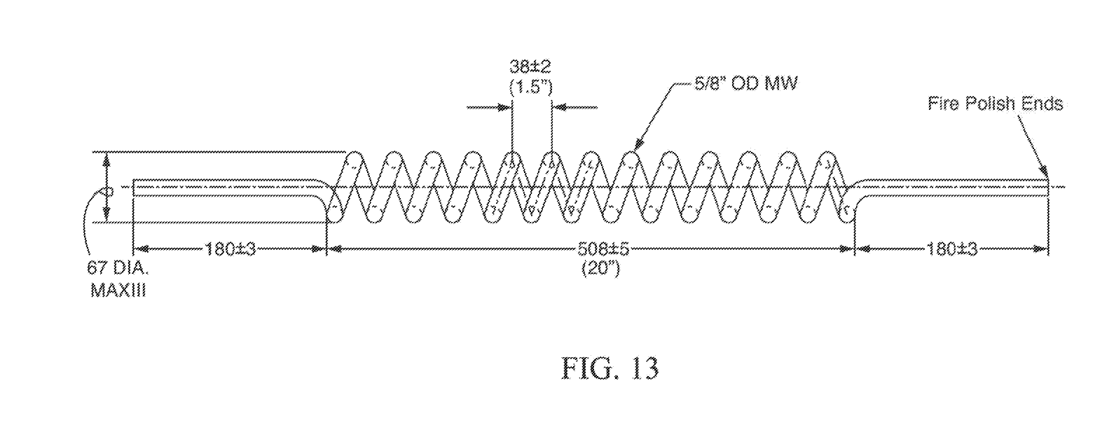

FIG. 13 is an illustration of a continuous ultrasonic system for treating seeds with ultrasound, involving a spiral or helical flow pipe design. The dimensions are only exemplary and are in millimeters (mm) unless otherwise noted. Dry seeds enter the helical tube, propelled from the intake or inlet to the outflow, outlet or exit by pumped compressed air or nitrogen gas under positive pressure. The pressurized gas forces dry seeds to rotate within the spiral tubing from the inlet end to the exit. If desired, the air or other gas can be subject to a negative pressure by a vacuum pump, used to induce the flow of the seeds in the gas through the helical flow pipe. This design employs a spiral or helical tubing or pipe to treat all sides of the seeds ultrasonically while the seeds are traversing the helical tube. Seeds travelling through the helical tube automatically rotate within the tubing and are exposed on all sides to ultrasound as they travel the length of the flow pipe. Relying on the spiral to provide soft gentle turning of the seeds within the ultrasonic treatment field, the use of the spiral both provides non-damaging seed rotation and shortens the overall length of the treatment apparatus.

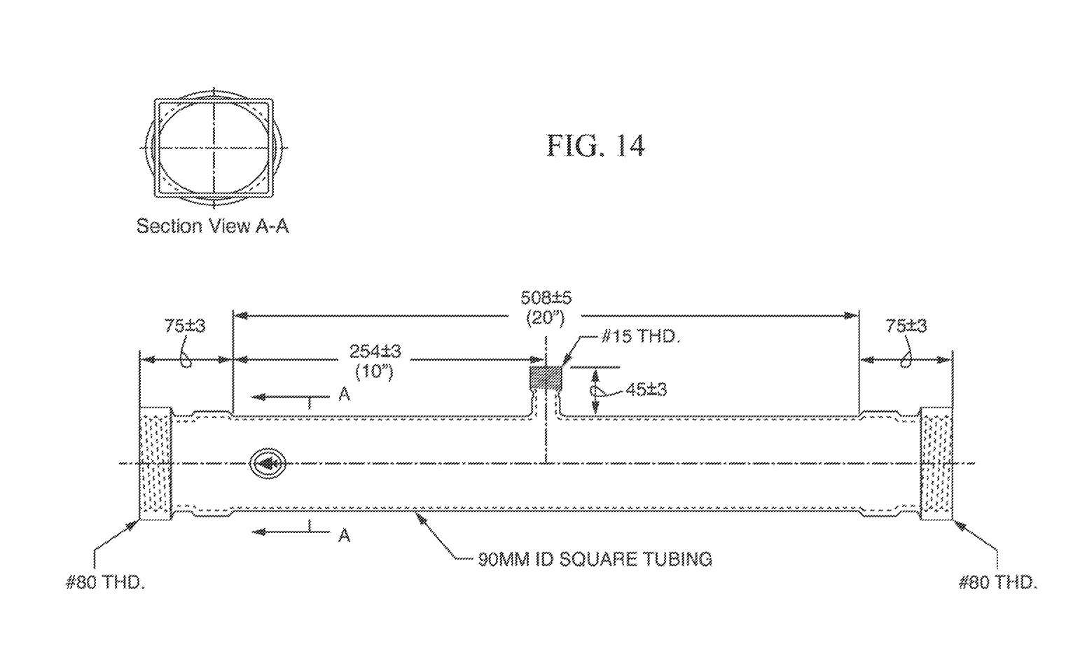

FIG. 14 is an illustration of a side view and a cross-section of a jacket which fits over and around the spiral or helical flow pipe illustrated in FIG. 13. Again, the dimensions are only exemplary and are in mm unless otherwise noted. The jacket, which can be loaded with cold or warm water or other liquid, such as an oil, like silicon oil, will allow the ultrasonic transmission from transducers placed on the exterior walls of the jacket, or alternatively on the interior walls of the jacket, preferably all of the exterior or interior walls where the jacket has a rectangular shape as shown in the cross-section A-A, along the length of the jacket, to treat the dry seeds which flow within the helical tubing that rotates the seeds as the seeds are traveling through the spiral tubing. The liquid may be loaded through a port on a side of the jacket, shown on the top of the jacket in FIG. 14.

The helical tubing, the jacket or both, can be made of a material that will allow the ultrasonic transmission through the jacket and helical tube from transducers placed on the exterior walls of the jacket. Suitable materials include, without limitation, quartz glass, stainless steel or flexible plastic. The helical tube also can be made of flexible plastic tubing.

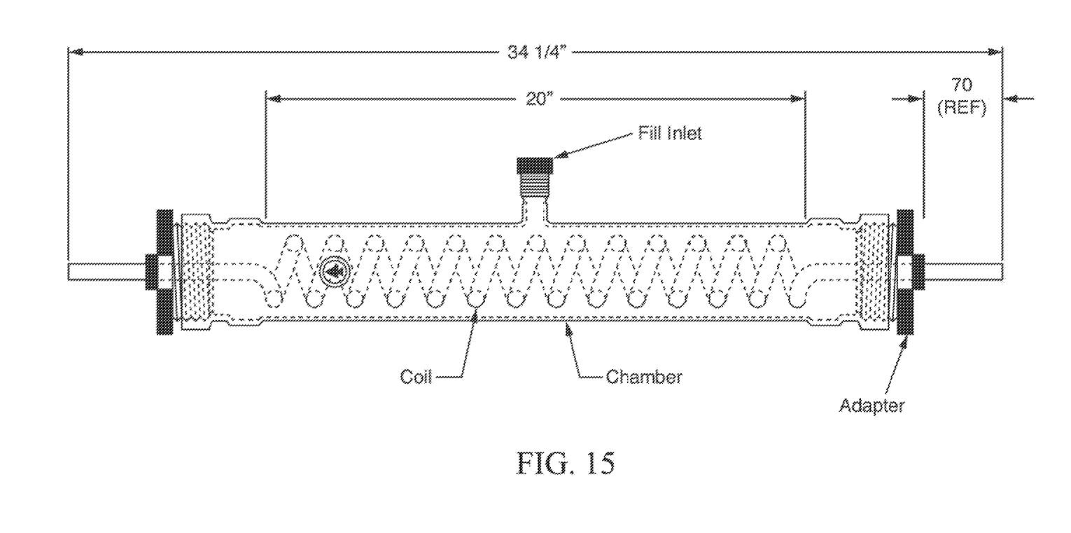

FIG. 15 is an illustration of the continuous processing system, which includes a jacket which fits over and around the spiral or helical flow pipe illustrated in FIG. 13, shown within the jacket in FIG. 15, and end caps at both ends of the spiral tubing screwed into the ends of the jacket. The end caps can be sealed with O-rings or gaskets against the jacket and helical tube, which passes through the end caps. As before, the dimensions are only exemplary and are in mm unless otherwise noted. FIG. 15 also shows a removable cap, preferably a screw cap, to seal the liquid loading port of the jacket.

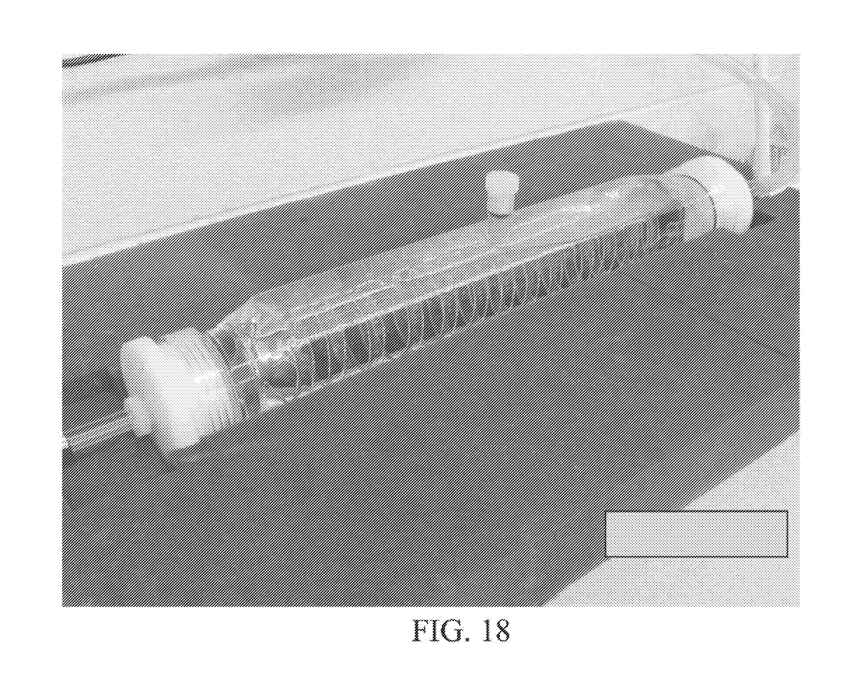

The photograph of FIG. 18 shows the full assembly shown in FIG. 15, minus the transducers.

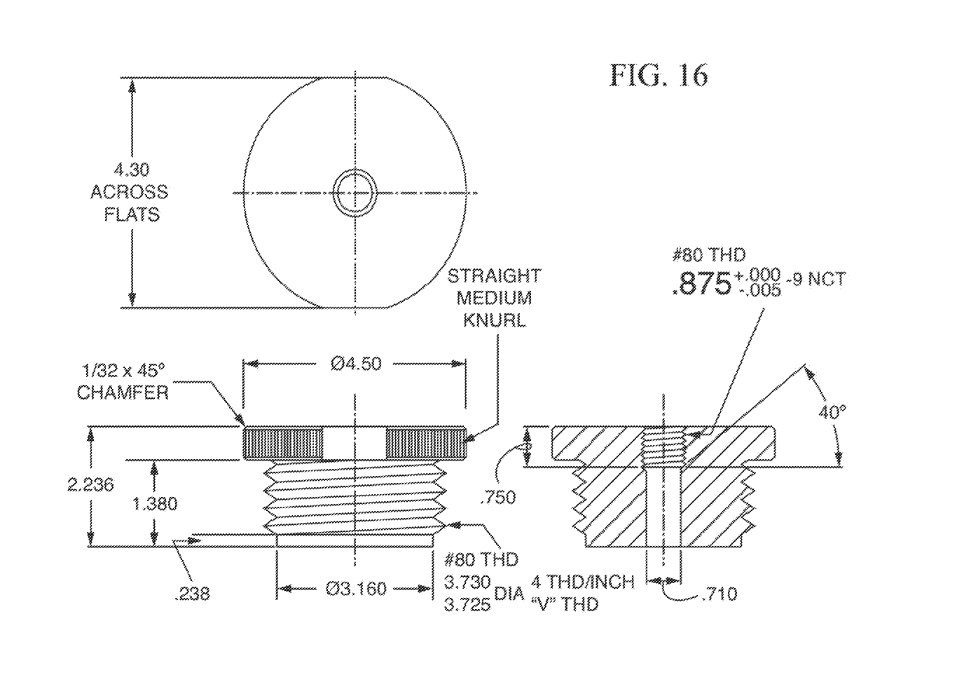

FIG. 16 is an illustration of the details of the end caps which fit onto the ends of the spiral tubing and are screwed into the jacket. Here, the dimensions are only exemplary and are in inches unless otherwise noted. While the endcaps are shown having male threads to screw into the mating female threads at the inlet and outlet ends of the jacket, alternatively, the male and female screws of the end caps and jacket can be reversed. The end caps can be made of nylon or other plastic.

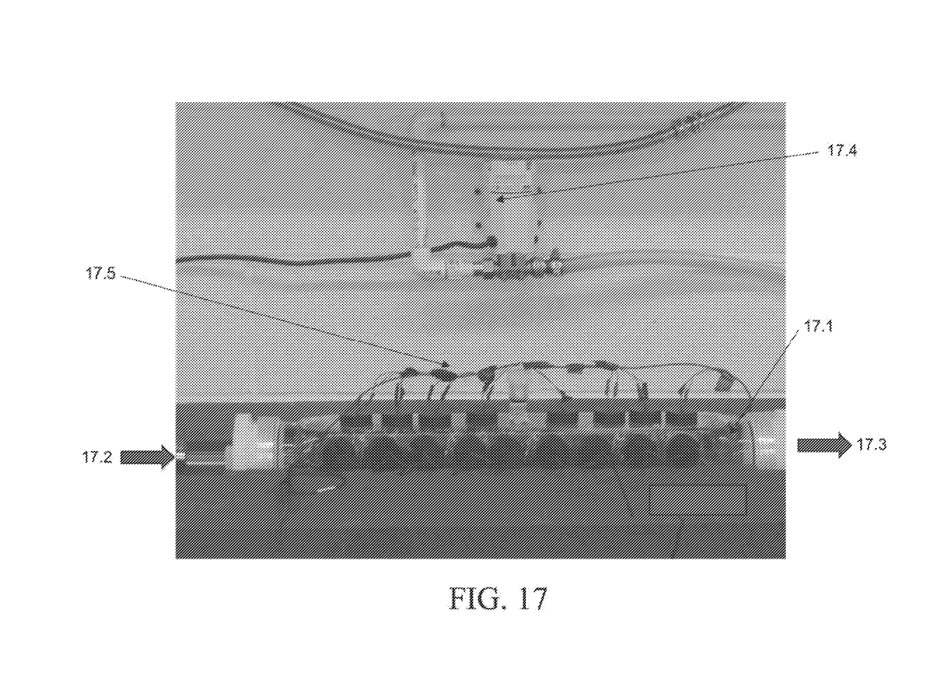

Preferably, compressed air or other gas can be used to drive the dry seeds through the helical flow pipe End Cap in Flow to the End Cap Outflow, under the ultrasound emanated from transducers placed along the length of the Jacket as shown in FIG. 17.

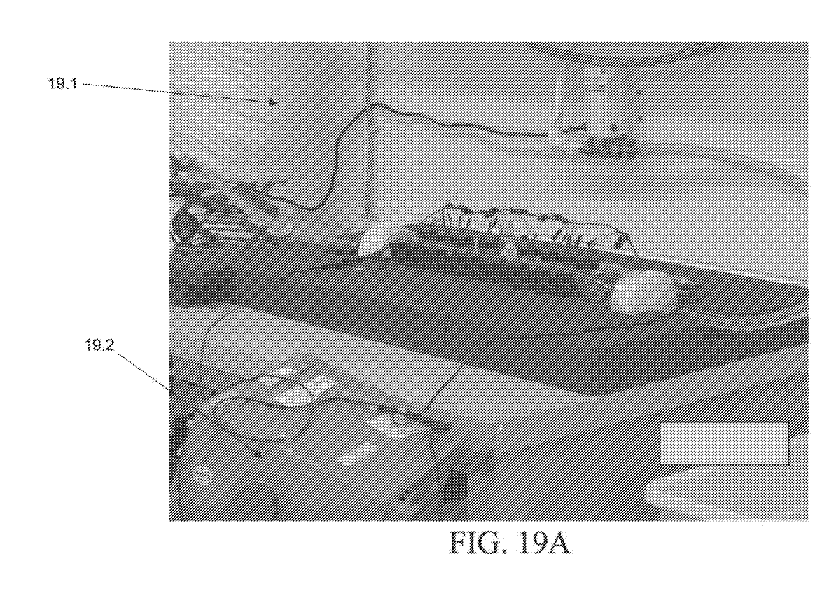

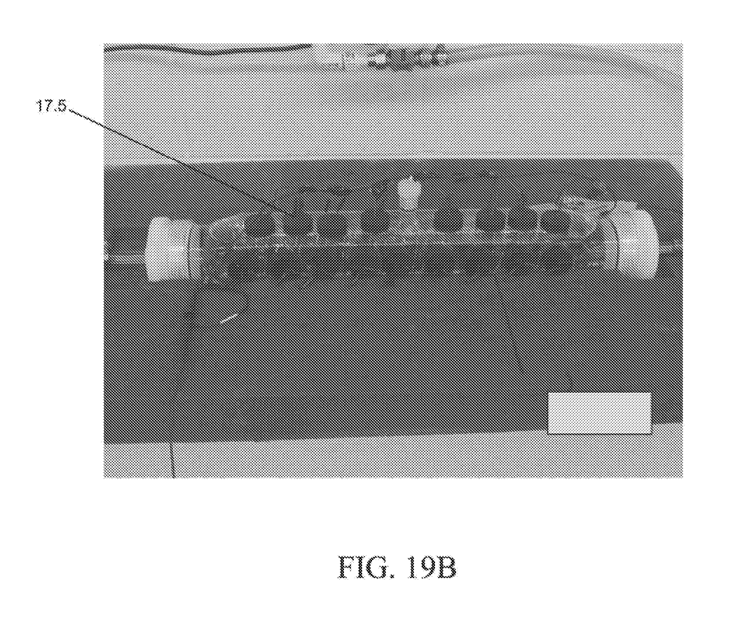

FIG. 17 shows a laboratory apparatus with a flow pipe in the form of the helical tube, wherein dry seeds enter the helix 17.1 at the inflow end cap 17.2 connected to the inlet end of the helical tube and to a conduit for the seeds and streaming or flowing air or other gas. The dry seeds immediately are exposed to ultrasound emanated from an array of transducers 17.5 on all sides of the jacket as they travel the length of the helical tube 17.1. Mobility for the dry seeds through the helical tube preferably is provided by a compressed air driver system 17.4 involving a regulator and flow valve in communication with a compressor or air cylinder. The compressed gas forces seeds from a storage tank 19.1 (shown in FIG. 19A) to travel the length of the helical tube 17.2 under ultrasonic treatment from the transducer array 17.5, and out the outflow end cap 17.3, which is connected to the helical tube outlet and to a conduit in communication with a container for the ultrasonically-treated dry seeds. Alternatively, the outlet conduit can connect back to the inlet conduit to recycle the seeds through the helical tube for additional ultrasonic treatment, if desired. The flow of the ultrasonically-treated seeds to the container or to be recycled can be controlled by a valve manually or automatically, as desired.

FIG. 19A is a photograph of the experimental model of the apparatus shown in FIGS. 17 and 18, involving the helical flow tube design, including the placement of transducers along the jacketed spiral ultrasound dry seed treatment system. The seed tank 19.1 is connected to the helical tube with its helical flow path. The transducers are powered by an ultrasonic generator 19.2 monitored by an oscilloscope.

FIG. 19B is photograph of the continuous processor system used in the experiments with the transducer array 17.5 placed along all sides of the jacketed helical tube.

The dry seeds may be treated by being subject to ultrasonic energy for treatment periods of more than about one minute, such as about 1 to about 20 minutes, and within that range, for example and ease of timing, for about 1, about 5, about 10, about 15 or about 20 minute exposures to the ultrasound. These are exemplary times using the laboratory batch treatment apparatus schematically illustrated in FIG. 10A, and further exemplified by FIGS. 10B, 10C, 11A, 11B and 11C. Treatment times may vary with other apparatus, so long as the treatment time is sufficient that sonically-treated dry seeds have an enhanced germination characteristic and plants resulting from the sonically-treated dry seeds have an enhanced growth characteristic.

In the continuous ultrasonic treatment process and apparatus for dry seeds the seeds are generally passed through the length of the helical flow path just once, but multiple treatments can be used to increase overall exposure times such that the sonically-treated dry seeds have an enhanced germination characteristic and plants resulting from the sonically-treated dry seeds have an enhanced growth characteristic.

### EXPERIMENTS

A series of experiments was performed to demonstrate the effectiveness of the treating seeds with ultrasonic energy, both proof of concept using a wet method where seeds were immersed in water, and a method according to the invention for the ultrasonic treatment of dry seeds. The experiments set forth below are non-limiting examples.

### Experiment 1—Ultrasonic Treatment of Wet Seeds for Comparison Purposes

The wet method experiments were conducted using the laboratory apparatus shown in FIG. 9 and according to the teachings of U.S. patent application Ser. No. 13/986,757, filed Jun. 3, 2013, published Dec. 4, 2014, under Publication No. US 2014/0352210 A1.

Two different crop seeds were examined, wheat and tomatoes. Each was sonicated at the same ultrasonic setting, using the transducer system shown in FIG. 9.

In FIG. 9 an ultrasonic generator known as Model B-2, and developed by Transdermal Specialties, Inc. of Broomall, Pa., USA, was used to generate the alternating ultrasonic transmission as shown in FIG. 7 and transmitted through water within a beaker holding the seeds in the wet method.

The ultrasonic settings for each wet seed experiment were:
Ultrasound Frequency 23-30 kHz
Intensity 0.5 W/sq·cm
Alternating Waveform Dynamic 50 msecs sawtooth/50 msecs square wave
Peak to Peak Voltage 0.2-0.5 mV

### Wet Treatment Procedure:

1. 10 grams of the target seeds, specifically corn, wheat, carrot and tomato seeds, were added to 1000 mL of tap water at ambient temperature in a beaker and stirred using a magnetic stirrer as shown in FIG. 9.

2. The ultrasound, emanating from an ultrasonic transducer tip immersed within the water is activated for 20 minute test intervals.

3. The seeds after sonification are then filtered and planted while still damp in test aquariums.

4. The results are shown in Table 1, which shows the normal time for germination of seeds tested and harvest time of plants grown from the tested seeds to full plant maturity vs. the times generated by the ultrasonic wet treatment. In each instance the wet ultrasonic treatment process produced significantly faster germination and final harvest growth times than the control untreated wet seeds.

TABLE 1

| | Crop | | | |
|---|---|---|---|---|
| | Wheat | Carrots | Corn | Tomato |
| Exp No | BKR-1000-98 | BKR- | BKR- | BKR- |
| | | 1000-102 | 1000-101 | 1000-98B |
| Normal time to | 7-10 Days | 14-21 Days | 7-10 Days | 7-10 Days |
| Germinate | | | | |
| Normal Time to | 89 Days | 75 Days | 89 Days | 80 Days |
| Harvest | | | | |
| U/S Days to | 4.10 Days* | 6.20 Days | 3.80 Days | 3.90 Days |
| Germinate | | | | |
| U/S Predicted | 37 | 42 | 41 | 35 |
| Days to Harvest | | | | |
| Predicted Days | 52 | 33 | 48 | 45 |
| Saved | | | | |

*The report of the time to germination of the ultrasonically-treated seeds in this row, for example 4.10 Days, means that 10 days was the average of days to germination of 4 sample runs of seeds treated per this example.

Experiments 2 and 3 were dry treatment experiments. The ultrasonic settings for these dry seed experiments were:

| | |
|---|---|
| Ultrasound Frequency | 23-30 kHz |
| Intensity | 0.5 W/sq. cm |
| Alternating Waveform | 50 msecs sawtooth/50 msecs square wave |
| Dynamic | |
| Peak to Peak Voltage | 0.2-0.5 mV |

### Experiment 2—Dry Seed Treatment Using Sonic Bag

The following procedure was followed for dry seed experiment 2.

1. 10 grams of the target seeds, namely corn and soybean, were added to a miniature Zip Lock® bag composed of a combination of Saran® and polyethylene, at ambient temperature according to the configuration shown in FIGS. 11A and 11B.

2. The ultrasound emanated from the two transducer blocks attached the sonic bag treat the seeds stored within the bag. The seeds after sonification do not require filtration or drying.

3. The seeds were exposed in the sonic bag for 1, 5, 10, 15 and 20 minute intervals.

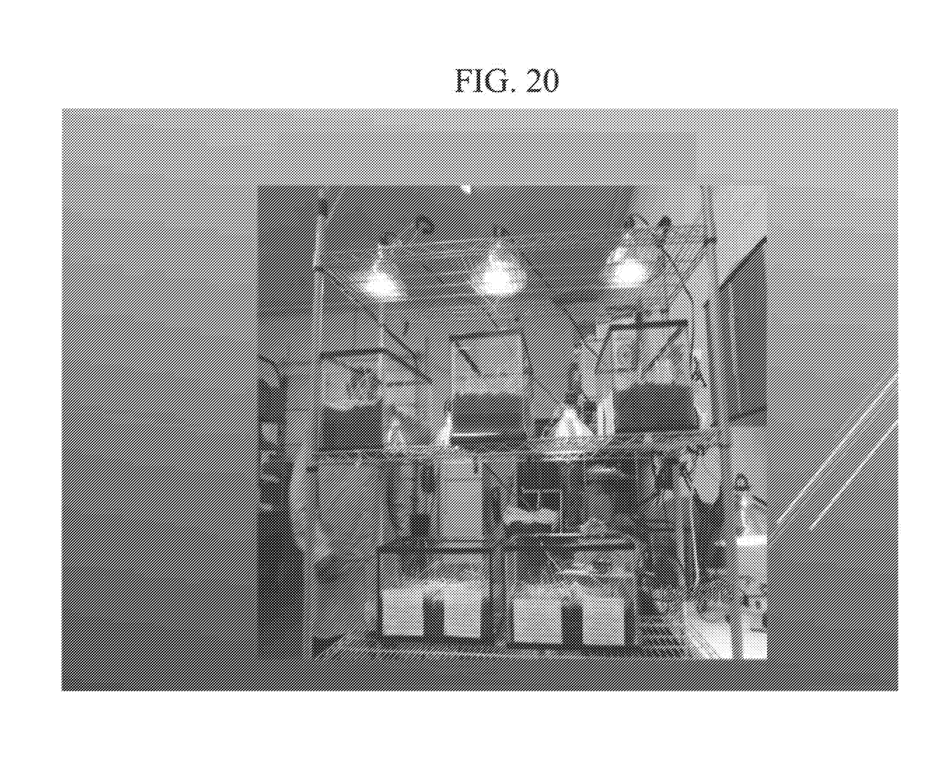

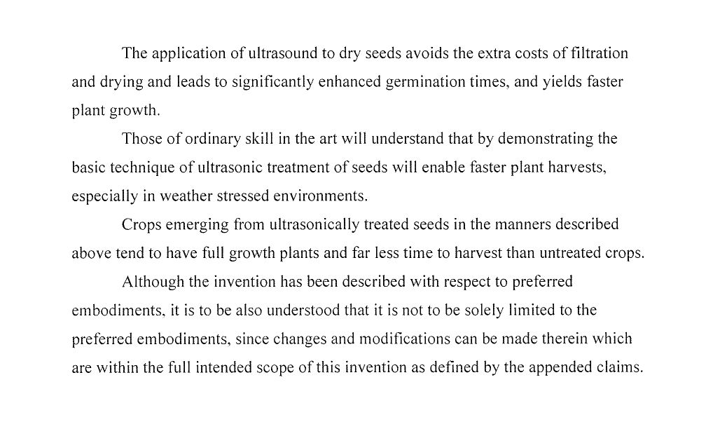

4. The ultrasonically treated seeds were then planted in test aquariums as shown in FIG. 20.

5. A comparison was made to show the point at which the treated seeds vs. untreated control seeds vs. wet treated seeds to determine the optimum treatment period giving the greatest yield and the fastest germination time.

Table 2 shows the results from experiments of direct seed sonification while the seeds were treated in a dry state under the laboratory sonic bag configuration.

TABLE 2

| | Crop | | | |
|---|---|---|---|---|
| | Corn | | Soybean | |
| Normal time to | 5-10 days | | 7-10 days | |
| Germinate | | | | |
| U/S Days to | Dry | Wet | Dry | Wet |
| Germinate | 3 Days | 3 Days | 5 Days | 4 Days |
| Best Treatment Times | 5 minutes | 1 minute | 5 minutes | 15 minutes |

| | | |
|---|---|---|
| Normal Time to | 89 Days | 45 to 64 Days |
| Harvest | | |
| U/S Predicted Days to | 41 Days | 20 to 28 Days |
| Harvest | | |
| Predicted Days Saved | 48 | 25 to 37 Days |

### Results

The normal germination period for corn was 5-10 days. Under wet ultrasonic treatment the germination time was reduced to 3 days, with the optimum treatment being 1 minute of ultrasonic exposure. The dry treatment showed best results after 5 minutes of ultrasonic treatment and germinated in 3 days for corn seeds.

The normal germination period for soy was 7-10 days. Under wet ultrasonic treatment the germination time was reduced to 4 days, with the optimum treatment being 15 minutes of ultrasonic exposure. The dry treatment showed best results after 5 minutes of ultrasonic treatment and germinated in 5 days for soybean seeds.

### Experiment 3—Dry Seed Experiment Using Continuous Helical System

The following procedure was followed for dry seed experiment 2.

1. The continuous helical system illustrated in FIGS. 19A and 19B was fabricated with a total length of 34.5 inches (87.6 cm) and a diameter of 3⅝ inches (9.2 cm) across the jacket, with the actual helical tube about 0.5 inch (1.3 cm) in diameter. The apparatus was constructed using a quartz glass construction which allows ultrasound to pass through the material without damaging the glass.

2. The helical jacket, as shown in FIG. 19B, was lined with 40 transducers total with 10 transducer blocks containing 4 transducer discs each as shown in FIG. 12B, placed on all four sides of the jacket.

3. The jacket was loaded with tap water at ambient temperature.

4. One pound (456 g) of the target seeds, namely corn and soybean, were added to a storage tank as shown in FIG. 19A and stored at ambient temperature for 1 full hour in the storage tank.

5. Compressed air was routed from a ½ inch (1.3 cm) diameter air line attached to a quarter turn air valve connected to a compressor set to deliver a stream of compressed air through the storage tank at 30 psi (207 kp) pressure.

6. Two different ultrasonic generators are connected to the transducers so that each generator operates 20 transducers. A mosfet bridge circuit was employed to balance the output of each transducer to the same frequency range. The ultrasound is set from the transducers to aim directly through the water jacket to the helical coil and through the coil to the seeds travelling within it. On average each seed is “hit” by or directly subjected to the ultrasonic transmission from all sides 10 times as it travels the length of the helical coil.

7. The ultrasound, emanating from the transducer blocks attached to the jacket, sonicates seeds which are propelled through the helical tube by the compressed air. The transit time for a seed through the helical tube is calculated to be 10 seconds to travel the length of the helical tube.

8. The seeds were exposed to the ultrasound in the helical tube for 1 to 5 passes through the helical treatment process.

9. The ultrasonically treated seeds were then planted in the test aquariums as shown in FIG. 20.

10. A comparison was made to show the point at which the sonically-treated seeds vs. untreated control seeds vs. wet treated seeds to determine the optimum treatment period giving the greatest yield and the fastest germination time.

Table 3 shows the results from direct seed sonification while the seeds were treated in a dry state under the helical continuous system.

TABLE 3

| | Crop | | | |
|---|---|---|---|---|
| | Corn | | Soybean | |
| Normal time to | 5-10 days | | 7-10 days | |
| Germinate | | | | |
| U/S Days to | Dry | Wet | Dry | Wet |
| Germinate | 3 Days | 3 Days | 5 Days | 4 Days |
| Best Treatment Times | 5 Passes | 1 minute | 5 Passes | 15 minutes |

| | | |
|---|---|---|
| Normal Time to | 89 Days | 45 to 64 Days |
| Harvest | | |
| U/S Predicted Days to | 41 Days | 20 to 28 Days |
| Harvest | | |
| Predicted Days Saved | 48 | 25 to 37 Days |

### Results

The normal germination period for corn was 5-10 days. Under wet ultrasonic treatment the germination time was reduced to 3 days, with the optimum treatment being 1 minute of ultrasonic exposure. The continuous dry treatment showed best results after 5 passes of ultrasonic treatment through the helical tube apparatus and germinated in 3 days for corn seeds.

The normal germination period for soybeans was 7-10 days. Under wet ultrasonic treatment the germination time was reduced to 4 days, with the optimum treatment being 15 minutes of ultrasonic exposure. The continuous dry treatment showed best results after 5 passes of ultrasonic treatment through the helical tube apparatus and germinated in a 5 days for soybean seeds.

### Planting Test Configuration

### Control Seeds

1. 5 grams of untreated control seeds were planted in a separate test aquarium in rows 2 inches (5.1 cm) apart from one another and stretching down the length of the test aquarium, 12 inches (30.5 cm), in soil placed in the aquariums at a depth of 8 inches (20.3 cm). The control seeds were placed 1.5 inches (3.8 cm) into the soil.

2. The control seeds were then covered with soil.

3. The control aquarium was placed under one Plant Growth lamp Model no. BR-30, 75 Watts, supplied by Phillips Co. The lamps were 15 inches (38.1 cm) away from the soil, generating a surface temperature of about 80° F. (26.7° C.).

4. The control aquarium was placed on a test rack under the lamps and connected to a timer which activated the lamps at 8:00 AM and deactivated the lamps at 6:00 PM.

5. The soil was irrigated with ¼ cup (118.3 ML) of tap water at ambient temperature each morning precisely at 9:00 AM.

6. FIG. 20 is a photograph of the test germination rack used in these experiments, containing soil laden aquariums under Plant Growth lamps.

### Ultrasonically-Treated Seeds

1. 5 grams of ultrasonically-treated seeds were planted in a separate test aquarium in rows 2 inches (5.1 cm) apart from one another and stretching down the length of the test aquarium (the “treated seed aquarium”), 12 inches (30.5 cm), in soil placed in the treated seed aquariums at a depth of 8 inches (20.3 cm). The treated seeds were placed 1.5 inches (3.8 cm) into the soil.

2. The ultrasonically-treated seeds were covered with soil.

3. Each treated seed aquarium was placed under one Plant Growth lamp Model no. BR-30, 75 Watts, supplied by Phillips Co. The lamps were 15 inches (38.1 cm) away from the soil, generating a surface temperature of about 80° F. (26.7° C.).

4. The treated seed aquariums were placed on a test rack under the lamps shown in FIG. 20 and connected to a timer which will activate the lamps at 8:00 AM and deactivate the lamps at 6:00 PM.

7. 5. The soil was irrigated with ¼ cup (118.3 ML) of tap water at ambient temperature each morning precisely at 9:00 AM.

Thus, the control seeds and the ultrasonically-treated seeds were planted and grown in the same manner in the same location.

### Operation

Both the control and test experiments are run until the seed germinated above the soil. The planting test has one control set of seeds vs. ultrasonically-treated seeds treated with the batch sonic bag experiment for 1, 5, 10, 15 and 20 minutes of exposure to ultrasound vs. ultrasonically-treated seeds treated continuously within the helical system for up to 5 passes.

### Observations

An examination of the seeds after ultrasonic exposure, using a scanning electron microscope, shows that the characteristic micro-holes shown in FIG. 8 were observed for all of the treated seeds with the laboratory system of FIG. 9 and the continuous helix system of FIGS. 19A and 19B.

While the above experiments were conducted using the apparatus described in FIGS. 11A and 11B or FIGS. 19A and 19B, the inventor believes that there are several ways to apply the ultrasound to a seed including, but not limited to, a conveyor system mounted with transducers. Any other devices would achieve the same sonification effect applied to seeds, either in a batch or continuous treatment processes. The preferred embodiment is one using the alternating ultrasound treatment applied to a seed which has been processed under a continuous system, ideally the helical system, to speed germination and potentially final harvest times.

Conventional sinusoidal ultrasound may still be effective with seed sonification, but the use of an alternating ultrasonic waveform system, which minimizes cavitation, is preferable.

### CONCLUSION

The experimentation listed above showed that ultrasound-induced water uptake represents a unique event dissociable from normal water uptake. These results demonstrate that ultrasound-stimulated seeds probably have faster rates of water uptake which is achieved very rapidly compared to the rates of water uptake of just soaked seeds. Thus, the sonication process fundamentally enhances the rate of uptake of substances into the seeds, speeding both seed germination and the growth of mature plants and crops. This process may therefore be used to reduce the time-to-harvest for many crops by first ultrasonically treating the seeds, including ultrasonically treating dry seeds.

While a wet ultrasonic treatment process appears to be more readily able to induce faster germination in seeds, the deficiencies of filtration followed by drying can make such system uneconomical.

1-50. (canceled)

51. A dry sonication process for a dry seed producing a sonically-treated dry seed having an enhanced germination characteristic and providing an enhanced growth characteristic to a plant resulting therefrom, the sonication process comprising:
subjecting the dry seed to be sonically treated to sound energy at a frequency and energy density and applying alternating ultrasonic waveforms for a sufficient time such that the sonically-treated dry seed has an enhanced germination characteristic and a plant resulting from the sonically-treated dry seed has an enhanced growth characteristic.

52. The dry sonication process of claim 51, wherein the sound energy is at a frequency of about 15 kHz to about 175 kHz.

53. The dry sonication process of claim 51, wherein the sound energy is at a frequency of about 20 kHz to about 100 kHz.

54. The dry sonication process of claim 51, wherein the sound energy is at a frequency of about 20 kHz to about 30 kHz.

55. The dry sonication process of claim 51, wherein the sound energy is at an energy density of about 0.125 watt/cm² to about 10 watts/cm².

56. The dry sonication process of claim 51, wherein the sound energy is at a frequency of about 20 kHz to about 30 kHz and at an energy density of about 0.5 watts/cm².

57. The dry sonication process of claim 51, wherein the sound energy is applied for about 1 minute or more.

58. The dry sonication process of claim 51, wherein the sound energy is applied for about 1 minute to about 20 minutes.

59. The dry sonication process of claim 51, wherein the sound energy is applied for about 5 minutes to about 20 minutes.

60. The dry sonication process of claim 51, wherein the sound energy does not produce cavitation treatment of the sonically-treated seed.

61. The dry sonication process of claim 51, wherein the alternating waveforms of the sound energy are applied for alternating periods of about 10 milliseconds to about 90 milliseconds.

62. The dry sonication process of claim 51, wherein the alternating ultrasonic waveforms of the sound energy are any two or more of a sinusoidal waveform, a sawtooth waveform, a triangular waveform and a square waveform.

63. The dry sonication process of claim 62, wherein the alternating ultrasonic waveforms of the sound energy are a sawtooth waveform alternating with a square waveform.

64. The dry sonication process of claim 63, wherein the alternating ultrasonic waveforms of the sound energy are applied for alternating periods of about 20 milliseconds to about 80 milliseconds.

65. The dry sonication process of claim 63, wherein the alternating ultrasonic waveforms of the sound energy are applied for alternating periods of about 50 milliseconds.

66. The dry sonication process of claim 51, wherein the sound energy is applied continuously.

67. The dry sonication process of claim 51, wherein the sound energy is applied in a pulsed manner.

68. The dry sonication process of claim 51, wherein the sonication process is a batch process or a continuous process.

69. The dry sonication process of claim 68, wherein the sonication process is a continuous process employing a continuous ultrasonic flow pipe.

70. A dry sonication process for continuously treating dry seeds with ultrasonic transmission, the process comprising:
continuously moving the dry seeds for a length of a flow pipe through a helical path within the flow pipe; and
as the dry seeds flow through the helical path within and for the length of the flow pipe, subjecting the seeds to ultrasonic transmission created by ultrasonic transducers arranged along the length of the flow pipe;
the dry seeds flowing through the helical path slurry being subjected to the ultrasonic transmission having such waveforms and being transmitted in a manner so as not to damage the seeds and to produce ultrasonically-treated seeds that have regulated germination characteristics, such that plants resulting from the ultrasonically-treated seeds when the seeds are planted have affected growth characteristics.

71. The dry sonication process of claim 70, wherein the regulated germination characteristics are enhanced germination characteristics.

72. The dry sonication process of claim 70, wherein the sound energy is at a frequency of about 15 kHz to about 175 kHz.

73. The dry sonication process of claim 70, wherein the sound energy is at a frequency of about 20 kHz to about 100 kHz.

74. The dry sonication process of claim 70, wherein the sound energy is at a frequency of about 20 kHz to about 30 kHz.

75. The dry sonication process of claim 70, wherein the sound energy is at an energy density of about 0.125 watt/cm² to about 10 watts/cm².

76. The dry sonication process of claim 70, wherein the sound energy is at a frequency of about 20 kHz to about 30 kHz and at an energy density of about 0.5 watts/cm².

77. The dry sonication process of claim 70, wherein the sound energy is applied for about 1 minute or more.

78. The dry sonication process of claim 70, wherein the sound energy is applied for about 1 minute to about 20 minutes.

79. The dry sonication process of claim 70, wherein the sound energy is applied for about 5 minutes to about 20 minutes.

80. The dry sonication process of claim 70, wherein the sound energy does not produce cavitation treatment of the sonically-treated seed.

81. The dry sonication process of claim 70, wherein the alternating waveforms are applied for alternating periods of about 10 milliseconds to less than 400 milliseconds.

82. The dry sonication process of claim 70, wherein the alternating waveforms of the sound energy are applied for alternating periods of about 10 milliseconds to about 90 milliseconds.

83. The dry sonication process of claim 70, wherein the alternating ultrasonic waveforms of the sound energy are any two or more of a sinusoidal waveform, a sawtooth waveform, a triangular waveform and a square waveform.

84. The dry sonication process of claim 83, wherein the alternating ultrasonic waveforms of the sound energy are a sawtooth waveform alternating with a square waveform.

85. The dry sonication process of claim 84, wherein the alternating ultrasonic waveforms of the sound energy are applied for alternating periods of about 20 milliseconds to about 80 milliseconds.

86. The dry sonication process of claim 84, wherein the alternating ultrasonic waveforms of the sound energy are applied for alternating periods of about 50 milliseconds.

87. The dry sonication process of claim 70, wherein the sound energy is applied continuously.

88. The dry sonication process of claim 70, wherein the sound energy is applied in a pulsed manner.

89. The dry sonication process of claim 70, wherein the continuous treatment involves recycling the dry seeds through the flow pipe for processing for such time to produce the ultrasonically-treated seeds that have the regulated germination characteristics, such that plants resulting from the ultrasonically-treated seeds when the seeds are planted have the affected growth characteristics.

90. Apparatus for treating dry seeds continuously with ultrasonic transmission, the dry seeds flowing for a length of a flow pipe through a flow path within the flow pipe, the apparatus comprising:
a flow pipe having a flow path from an inlet to an outlet of the flow pipe; and
a plurality of ultrasonic transducers with a power supply for generating the ultrasonic transmission by the transducers, the transducers arranged along the length of the flow pipe and of sufficient number and placement to provide ultrasonic transmission to the flowable slurry of seeds as they travel through the flow path;
the ultrasonic transmission being applied by the ultrasonic transducers in a manner so as not to damage the seeds and to produce ultrasonically-treated seeds that have regulated germination characteristics, such that plants resulting from the ultrasonically-treated seeds when the seeds are planted have affected growth characteristics.

91. The apparatus of claim 90, wherein the regulated germination characteristics are enhanced germination characteristics.

92. The apparatus of claim 90, wherein the flow path is a helical flow path formed by a helical tube spiraling for the length of the flow pipe for the helical flow path from an inlet to an outlet of the flow pipe; and the transducers arranged along the length of the flow pipe and of sufficient number and placement to provide ultrasonic transmission to the flowable slurry of seeds as they travel through the helical flow path.

93. The apparatus of claim 92, further comprising:
a source of supply to supply the dry seeds to an inlet into the helical tube;
an air mover for moving the dry seeds by positive or negative air pressure on the dry seeds the length of the spiral tube;
a jacket over the helical tube which to contain a liquid surrounding the helical tube;
at least one ultrasonic generator to power the transducers capable of imparting ultrasonic energy though walls of the jacket, through the liquid within the jacket and through walls of the helical tube to sonicating the dry seeds flowing through the helical tube; and
an outflow connection from the helical tube through which the ultrasonically-treated dry seeds will pass out of the helical tube.

94. The apparatus of claim 93, further comprising at least one conduit communicating from the outflow connection to the inlet to recycle the ultrasonically-treated dry seeds through the apparatus until the dry seeds are ultrasonically treated for a sufficient time that the ultrasonically-treated dry seeds have the regulated germination characteristics, such that plants resulting from the ultrasonically-treated seeds when the seeds are planted have the affected growth characteristics.

95. The apparatus of claim 93, wherein the liquid within the jacket is selected from water or oil.

96. The apparatus of claim 95, wherein the oil is silicone oil.

97. The apparatus of claim 92, wherein the helical tube and the jacket are formed from a material which will allow ultrasonic transmission to pass through the material, and wherein the material is quartz glass, stainless steel or flexible plastic.

98. A dry ultrasonically-treated seed produced by the dry sonication process of claim 51.

99. A dry ultrasonically-treated seed produced by the dry sonication process of claim 70.

100. A dry ultrasonically-treated seed produced using the apparatus of claim 90.
